(19) United States
(12) Patent Application Publication
(10) Pub. No.: US 2024/0334420 A1
(43) Pub. Date: Oct. 3, 2024

(54) SYSTEMS, APPARATUSES, AND METHODS FOR SCHEDULING COOPERATIVE DATA TRANSMISSION IN A WIRELESS COMMUNICATION NETWORK

(71) Applicant: HUAWEI TECHNOLOGIES CO., LTD., Shenzhen (CN)

(72) Inventors: Hua Xu, Ottawa (CA); Jianglei Ma, Ottawa (CA)

(21) Appl. No.: 18/743,582

(22) Filed: Jun. 14, 2024

Related U.S. Application Data
(63) Continuation of application No. PCT/CN2022/133970, filed on Nov. 24, 2022.
(60) Provisional application No. 63/289,791, filed on Dec. 15, 2021.

(51) Int. Cl. H04W 72/121; H04W 72/232; H04W 72/40; H04W 92/18

(52) U.S. Cl. CPC H04W 72/121; H04W 72/232; H04W 72/40; H04W 92/18

(57) ABSTRACT

In a user equipment (UE) cooperation group in wireless communications, a radio access network (RAN) may schedule data transmission between the RAN and a primary UE (PUE) at least partially via at least one cooperative UE (CUE). The PUE and CUE may communicate with the RAN via Uu links and with each other via sidelinks therebetween based on schedule information generated during the scheduling. The RAN transmits a control signal for the PUE and the CUE. The control signal carries the scheduling information for scheduling the data transmission between the RAN, the CUE, and the PUE. The control signal may be carried by a physical downlink control channel (PDCCH) signal scrambled by at least a group-ID assigned to the PUE and the CUE.

### CROSS-REFERENCE TO RELATED APPLICATIONS

This application is a continuation application of international application No. PCT/CN2022/133970, filed on Nov. 24, 2022, which claims the benefit of U.S. Provisional Patent Application Ser. No. 63/289,791, filed Dec. 15, 2021, the content of each of which is incorporated herein by reference in its entirety.

### TECHNICAL FIELD

The present disclosure relates generally to systems, apparatuses, and methods for data transmissions in wireless communication networks, and in particular to systems, apparatuses, and methods for scheduling cooperative data transmissions between a network node of a wireless communication network and a user equipment (UE) at least partially via at least one other UE.

### REFERENCE TO ACRONYM KEY

For case of reading, subsection D of the Detailed Description lists the acronyms used in this disclosure.

### BACKGROUND

In Long Term Evolution (LTE) communication networks, user equipments (UEs) can communicate directly with each other. In LTE communications networks, direct communications between UEs is generally referred to a LTE Device-to-Device (D2D) communications. Research on LTE D2D was primarily focused on communications between UEs. New Radio (NR) communication networks support vehicle to anything (V2X) communications, and NR D2D research has focused on Uu link communications between a gNodeB (gNB, which is a base station of a radio access network (RAN)) and UEs, and on “sidelink” communications between UEs.

For Uu link communications with a gNB, such as uplink transmissions, a UE is limited in terms of its functions, features, or operations, by such factors as its number of antennas, total available transmit power, specified or mandated restrictions on transmit power, and ability to support operating or communicating in modes. For example, some UEs may support carrier aggregation or dual connectivity. Other factors may also or instead limit functions, features, or operations of a UE.

The limitations in the functions, features, or operations of a UE, especially in respect of Uu link communications with a gNB, may directly impact performance of not only the UE, but also more generally communication system performance.

UE cooperation is a communication technique that focuses on processes among multiple UEs in a group of UEs (generally referred to as a UE-cooperation group) that are involved in cooperative data transmissions and/or data receptions. UE cooperation may be achieved by having multiple UEs in a UE-cooperation group assisting one UE of the multiple UEs with either or both of data communications with a gNB, or sidelink communications with another UE inside the UE-cooperation group. UE cooperation may be useful, for example, to enhance the functions, features, or operations of the UEs in a group of UEs such as any one or more of communication network throughout, coverage, capacity, latency, and reliability. However, UE cooperation may introduce challenges in terms of managing data transmissions to and from a UE of a UE-cooperation group such as causing a significant amount of scheduling-signal transmissions in the UE-cooperation group during the scheduling of the cooperative data transmission, thereby leading to increased data transmission latency and/or reduced efficiency of communication channel usage.

### SUMMARY

According to one aspect of this disclosure, there is provided a first method comprising: scheduling a data transmission between one or more radio access network (RAN) nodes such as one or more base stations of a RAN and a first user equipment (UE) at least partially via at least one other UE; and transmitting, by the one or more RAN nodes, a control signal for the first UE and the at least one other UE, the control signal carrying scheduling information of the scheduled data transmission between the one or more RAN nodes of the RAN and the first UE at least partially via the at least one other UE. The one or more RAN nodes may be part of a serving cell and the first UE is configured to communicate with the one or more RAN nodes.

In some embodiments, the first method further comprises transmitting at least a first portion of data to the at least one other UE based on the scheduling information for the at least one other UE to forward to the first UE.

In some embodiments, the first method further comprises transmitting at least a second portion of the data to the first UE based on the scheduling information.

In some embodiments, the first method further comprises receiving at least a first portion of data of the first UE from the at least one other UE based on the scheduling information.

In some embodiments, the first method further comprises: receiving a second portion of data from the first UE based on the scheduling information; and combining the at least first portion of data and the second portion of data.

In some embodiments, the first method further comprises assigning, by the RAN, a group identifier (group-ID) to the first UE and the at least one other UE.

In some embodiments, the control signal comprises at least one physical downlink control channel (PDCCH) signal carrying the scheduling information.

In some embodiments, the at least one PDCCH signal is scrambled by at least the group-ID.

In some embodiments, said transmitting the control signal for the first UE and the at least one other UE comprises: transmitting a first one of the at least one PDCCH signal in a UE-specific search space for the first UE; and transmitting a second one of the at least one PDCCH signal in a UE-specific search space for the at least one other UE.

In some embodiments, the first one of the at least one PDCCH signal is the same of the second one of the PDCCH signal.

In some embodiments, the first one of the at least one PDCCH signal carries a first downlink control information (DCI) having a full set of the scheduling information, and the second one of the at least one PDCCH signal carries a second DCI having a reduced set of the scheduling information.

In some embodiments, the first one of the at least one PDCCH signal is for the first UE, and the second one of the PDCCH signal is for the at least one other UE.

In some embodiments, said transmitting the control signal for the first UE and the at least one other UE comprises: transmitting the at least one PDCCH signal in a group common search space identified by at least the group-ID.

In some embodiments, the group common search space is in a control resource region associated with a common search space of the at least one PDCCH signal.

In some embodiments, the group common search space is in a control resource region associated with a UE-specific search space of the at least one PDCCH signal.

According to one aspect of this disclosure, there is provided an apparatus comprising: one or more processors for performing the above-described first method.

According to one aspect of this disclosure, there is provided one or more non-transitory computer-readable storage devices comprising computer-executable instructions, wherein the instructions, when executed, cause a processing structure to perform the above-described first method.

According to one aspect of this disclosure, there is provided a second method comprising: receiving, by a first UE, a control signal transmitted by one or more RAN nodes of a RAN, the control signal carrying scheduling information for data transmissions between a source node and a destination node; after decoding the control signal by the first UE, determining, by the first UE, that the source node and the destination node indicated in the scheduling information carried in the control signal are different from the first UE; and receiving, by the first UE, data based on the scheduling information.

In some embodiments, said receiving, by the first UE, the data based on the scheduling information comprises receiving, by the first UE, the data transmitted by a second UE based on the scheduling information; and the second method further comprises: transmitting, by the first UE, the received data to the one or more RAN nodes of the RAN based on the scheduling information.

In some embodiments, said receiving, by the first UE, the data based on the scheduling information comprises: receiving, by the first UE, the data transmitted by the one or more RAN nodes of the RAN based on the scheduling information; and the second method further comprises transmitting the received data to a second UE.

In some embodiments, the control signal comprises a PDCCH signal carrying the scheduling information.

In some embodiments, the PDCCH signal is scrambled by at least a group-ID.

In some embodiments, said receiving, by the first UE, the control signal transmitted by the one or more RAN nodes of the RAN comprises: searching, by the first UE, for the PDCCH signal in a group common search space; and retrieving, by the first UE, the scheduling information carried in the PDCCH signal received in the group common search space.

In some embodiments, the group common search space is in a control resource region associated with a common search space.

In some embodiments, the group common search space is in a control resource region associated with a UE-specific search space.

In some embodiments, said receiving, by the first UE, the control signal transmitted by the one or more RAN nodes of the RAN comprises: searching, by the first UE, for the PDCCH signal in a UE-specific search space; and retrieving, by the first UE, the scheduling information from the PDCCH signal received in the UE-specific search space.

In some embodiments, the UE-specific search space is the UE-specific search space of the first UE or the second UE.

According to one aspect of this disclosure, there is provided an apparatus comprising: one or more processors for performing the above-described second method.

According to one aspect of this disclosure, there is provided one or more non-transitory computer-readable storage devices comprising computer-executable instructions, wherein the instructions, when executed, cause a processing structure to perform the above-described second method.

According to one aspect of this disclosure, there is provided a third method comprising: receiving, by a first UE, a control signal transmitted by one or more RAN nodes of a RAN, the control signal carrying scheduling information for data transmission between the first UE and the one or more RAN nodes of the RAN at least partially via at least one other UE; transmitting or receiving, by the first UE, at least a first portion of data to or from the at least one other UE.

In some embodiments, said transmitting or receiving, by the first UE, the at least first portion of data from the at least one other UE comprises: receiving, by the first UE, the at least first portion of data from the at least one other UE based on the scheduling information.

In some embodiments, the third method further comprises: receiving, by the first UE, a second portion of data transmitted by the one or more RAN nodes of the RAN based on the scheduling information; and combining, by the first UE, the at least first portion of data and the second portions of data.

In some embodiments, said transmitting or receiving, by the first UE, the at least first portion of data to or from the at least one other UE comprises: transmitting, by the first UE, the at least first portion of data to the at least one other UE for the at least one other UE to transmit to the one or more RAN nodes of the RAN.

In some embodiments, said transmitting, by the first UE, the at least first portion of data to the at least one other UE comprises: transmitting, by the first UE, the at least first portion of data to the at least one other UE based on the scheduling information for the at least one other UE to transmit to the one or more RAN nodes of the RAN.

In some embodiments, the third method further comprises: transmitting, by the first UE, a second portion of data to the one or more RAN nodes of the RAN based on the scheduling information.

In some embodiments, the control signal comprises a PDCCH signal carrying the scheduling information.

In some embodiments, the PDCCH signal is scrambled by at least a group-ID.

In some embodiments, said receiving, by the first UE, the control signal transmitted by the one or more RAN nodes of the RAN comprises: searching, by the first UE, the control signal in a group common search space; and retrieving, by the first UE, the scheduling information from the control signal received in the group common search space.

In some embodiments, the group common search space is in a control resource region associated with a common search space of the PDCCH signal.

In some embodiments, the group common search space is in a control resource region associated with a UE-specific search space of the PDCCH signal.

In some embodiments, said receiving, by the first UE, the control signal transmitted by the one or more RAN nodes of the RAN comprises: searching, by the first UE, the control signal in a UE-specific search space; and retrieving, by the first UE, the scheduling information from the control signal received in the UE-specific search space.

In some embodiments, the UE-specific search space is the UE-specific space of the first UE or the at least one other UE.

According to one aspect of this disclosure, there is provided an apparatus comprising: one or more processors for performing the above-described third method.

According to one aspect of this disclosure, there is provided one or more non-transitory computer-readable storage devices comprising computer-executable instructions, wherein the instructions, when executed, cause a processing structure to perform the above-described third method.

By using group-based control signals, the systems, apparatuses, and methods disclosed herein provide improved efficiency and reduced latency for cooperative data transmissions and cooperative data receptions, and enable more efficient cooperative data transmissions and cooperative data receptions between a RAN and a UE. More specifically, UEs of a cooperation group receive a single schedule for cooperative data transmissions, thereby leading to more efficient relaying/forwarding of data transmitted by a RAN destined for a target UE (TUE) by cooperative UEs (CUEs) or to more efficient forwarding/relaying of data transmitted by a source UE (SUE) destined for a RAN by CUEs.

### BRIEF DESCRIPTION OF THE DRAWINGS

FIG. 1 is a simplified schematic diagram showing a communication system, according to some embodiments of this disclosure;

FIG. 2 is a simplified schematic diagram of a base station of the communication network of the communication system shown in FIG. 1;

FIG. 3 is a simplified schematic diagram of a user equipment (UE) of the communication system shown in FIG. 1;

FIG. 4 is a simplified schematic diagram showing cooperative data transmission and cooperative data reception between a primary UE (PUE, which may be a source UE (SUE) or a target UE (TUE)) and a base station of the communication system shown in FIG. 1, wherein the cooperative data transmission between the PUE and the RAN may be performed directly therebetween or via a cooperative UE (CUE);

FIG. 5A is a call flow diagram showing communications for cooperative uplink (UL) data transmissions from a PUE (which is a SUE in this figure) to a base station via a CUE;

FIG. 5B is call flow diagram showing communications for cooperative downlink (DL) data transmissions from a base station to a PUE (which is a TUE in this figure) via a CUE;

FIGS. 6A to 6C are flowcharts showing processes performed by a base station of a RAN, a PUE, and one or more CUEs, respectively, for cooperative data transmission between the base station and the PUE via the one or more CUEs using group-based scheduling, according to some embodiments of this disclosure, wherein

FIG. 6A shows a process performed by the RAN,

FIG. 6B shows a process performed by a CUE, and

FIG. 6C shows a process performed by the PUE;

FIG. 7 is flowchart showing a process performed by a base station of a RAN, according to some alternative embodiments of this disclosure;

FIG. 8A is a call flow diagram showing an example of cooperative UL data transmission from a PUE to a RAN via a CUE;

FIG. 8B is a call flow diagram showing an example of cooperative DL data transmission from a RAN to a PUE via a CUE;

FIG. 9 is a simplified block diagram showing an example of cooperative data transmission between a PUE and a RAN using two CUEs;

FIG. 10 is a simplified block diagram showing another example of cooperative data transmission between a PUE and a RAN using a CUE;

FIG. 11 is a simplified block diagram showing yet another example of UE cooperation for data transmission between a PUE and a RAN via two base stations, and a CUE;

FIG. 12A is a graph showing a group common search space and a UE-specific search space in different frequency bands;

FIG. 12B is a simplified schematic diagram showing a group common search space and a UE-specific search space at different time slots;

FIG. 13 is a simplified schematic diagram showing a group common search space configured to transmit a group-based Physical Downlink Control Channel (PDCCH) signal and a UE-specific PDCCH signal;

FIG. 14 is a simplified schematic diagram showing a first UE-specific search space for a first UE and a second UE-specific search space for a second UE, wherein the first UE-specific search space is configured for transmitting a group-based PDCCH for scheduling cooperative data transmission for the first UE and a conventional non-cooperative PDCCH for scheduling non-cooperative data transmission for the first UE, and the second UE-specific search space is configured for transmitting a group-based PDCCH for scheduling cooperative data transmission for the second UE and a conventional non-cooperative PDCCH for scheduling non-cooperative data transmission for the second UE;

FIG. 15A shows a RAN and three UEs of a UE-cooperation group performing two cooperative data transmissions;

FIG. 15B is a simplified schematic diagram showing a group-based PDCCH carrying scheduling information for two scheduling incidents;

FIG. 16 shows a RAN and three UEs of a UE-cooperation group with unscheduled sidelinks, wherein the RAN only schedules data transmissions via the Uu link between the RAN and each UE, and does not schedule data transmissions via the sidelinks;

FIG. 17 shows a PUE 114A using one of two CUEs of a UE-cooperation group for cooperative data transmission between the PUE and a RAN;

FIG. 18A is a simplified schematic diagram showing a group-based PDCCH transmitted using a group common search space;

FIG. 18B is a graph showing a group-based PDCCH transmitted using a UE-specific search space;

FIG. 18C is a graph showing a group-based PDCCH transmitted using the UE-specific search space of a PUE and the UE-specific search space of a CUE;

FIGS. 19A to 19C are graphs showing a control signal comprising a first group-based PDCCH for a PUE for scheduling data transmissions via sidelink from the PUE to a CUE, and a second group-based PDCCH for the CUE for scheduling data transmissions via Uu link from the CUE to a RAN, wherein

FIG. 19A is a graph showing the first and second group-based PDCCHs transmitted in a common search space,

FIG. 19B is a graph showing the first and second group-based PDCCHs transmitted in a UE-specific search space of the PUE or the CUE, and

FIG. 19C is a graph showing the first and second group-based PDCCHs transmitted in a UE-specific search space of the PUE and a UE-specific search space of the CUE;

FIGS. 20A to 20C are simplified schematic diagram showing a PDCCH having a scrambled payload and a cyclic redundancy check (CRC) field masked by a CRC mask, wherein

FIG. 20A is a simplified schematic diagram showing the CRC field of the PDCCH masked with a CRC mask formed by one or more of a group-ID and a local UE ID,

FIG. 20B is a simplified schematic diagram showing X-bit sequences containing group identifier or group radio network temporary identifier (group-ID/group-RNTI) combined with Y-bit sequences containing local UE ID used to generate the CRC mask, and

FIG. 20C is a simplified schematic diagram showing the bit level scrambling of the payload of the PDCCH;

FIG. 21A is flowchart of a process performed by a CUE in a UE-cooperation group that is performing cooperative DL data transmission, according to one embodiment of this disclosure;

FIG. 21B is flowchart of a process performed by a TUE in a UE-cooperation group that is performing cooperative DL data transmission;

FIG. 22A is flowchart of a process performed by a SUE in a UE-cooperation group that is performing cooperative UL data transmission, according to one embodiment of this disclosure; and

FIG. 22B is flowchart of a process performed by another CUE in a UE-cooperation group that is performing cooperative UL data transmission.

### DETAILED DESCRIPTION

Embodiments disclosed herein relate to cooperative data transmissions in wireless communications between a radio access network (RAN) and a primary UE (PUE, which may be a source UE (SUE) transmitting data to the RAN or a target UE (TUE) receiving data from the RAN) via one or more cooperative UEs (CUEs). The UEs may communicate with the RAN via Uu links and communicate with each other via sidelinks therebetween. In some embodiments, the sidelinks are specified by the 3GPP standard and transmissions via the sidelinks may be scheduled by the RAN 102 (for example, based on PC5 interface). In some other embodiments, the sidelinks are not specified by the 3GPP standard and therefore transmissions via sidelinks may not be scheduled by the RAN 102. Such types of sidelinks are referred as unscheduled or unspecified sidelinks (or inter-UE link, inter-UE connection) herein.

In some embodiments, the methods performed by the PUE and CUEs use group-based control signal(s) (that is, control signal(s) identified by a group identifier (group-ID); also denoted “group-specific control signal(s)” hereinafter) for carrying scheduling information for cooperative transmissions of data to a TUE via at least one CUE and/or receptions of data transmitted by a SUE via at least one CUE.

Herein, a group-based control signal is a control signal sent from one or more base stations of the RAN to a plurality of UEs. In some embodiments, the plurality of UEs may be assigned a group-ID and the control signal may carry, in addition to the scheduling information, the group-ID such that each of the UEs may decode the control signal based on the group-ID.

In some embodiments, the group-based control signal may be a group-based Physical Downlink Control Channel (PDCCH) signal (also denoted as “group-specific PDCCH signal”) and the group-ID (also denoted as the “group-based ID”) may be a group Radio Network Temporary Identifier (RNTI).

In some embodiments, the group-based PDCCH may carry scheduling information for different scenarios of cooperative data transmission, including unspecified sidelink or 3GPP specified sidelink.

In some embodiments, the group-based PDCCH may carry scheduling information that contains one or more scheduling incidents for one or more cooperative data transmissions and/or data receptions.

In some embodiments, the group-based PDCCH may carry scheduling information that explicitly or implicitly indicate one or more CUEs scheduled for cooperative data transmissions/receptions.

The group-based PDCCH signal may be transmitted in a group common search space or UE-specific search spaces of a downlink (DL) radio frame, and may be scrambled and/or cyclic redundancy check (CRC) masked (or CRC scrambled) by the group-RNTI and other parameters. Therefore, the PDCCH search procedure (that is, process) performed by PUEs and CUEs is simplified. The number of PDCCH signals transmitted is also reduced.

By using group-based control signals, the methods disclosed herein for cooperative data transmission provide improved efficiency and reduced latency for UEs of a cooperation group that are assisting with data transmission by a SUE or data reception by a TUE, and enable more efficient cooperative data transmissions and/or data receptions between the RAN and the PUE. More specifically, UEs operating in the UE cooperation mode may receive a single schedule for cooperative data transmissions, thereby leading to more efficient data relaying/forwarding by CUEs from the RAN to a TUE or to more efficient data forwarding/relaying by CUEs from a SUE to the RAN.

### A. System Structure

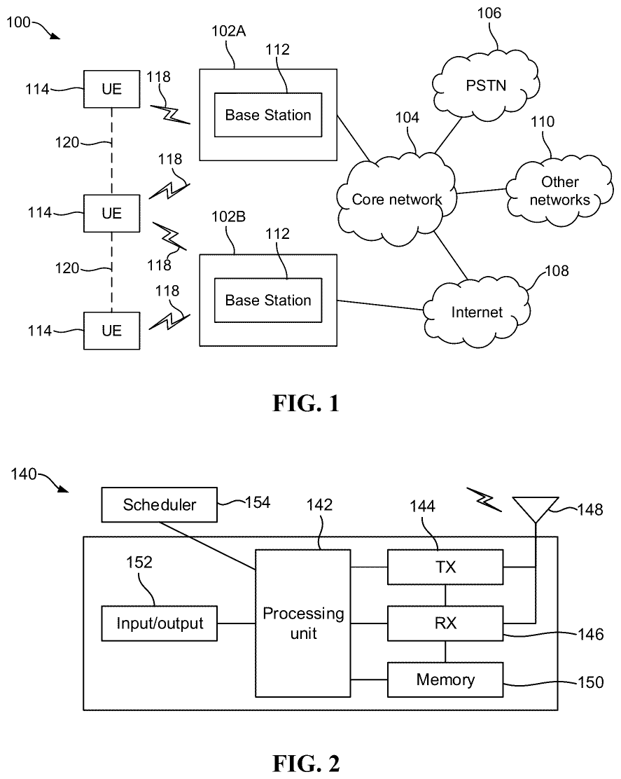

Turning now the FIG. 1, a communication system according to some embodiments of this disclosure is shown and is generally identified using reference numeral 100. The communication system 100 enables a plurality of UEs to communicate data and other content, and may provide content (such as voice, data, video, text, and/or the like) via broadcast, multicast, unicast, UE-to-UE, and/or the like. The communication system 100 may operate efficiently by sharing communication resources such as time, frequency, and/or space resources.

In these embodiments, the communication system 100 comprises two RANs 102A and 102B (each generally referred to as a RAN 102 and collectively referred to as RANs 102) connecting to a core network 104 directly or indirectly (for example, via the internet 108). The core network 104 may be in communication with one or more communication networks such as a public switched telephone network (PSTN) 106, the internet 108, and/or other networks 110. PSTN 106 may include circuit switched telephone networks for providing plain old telephone service (POTS). Internet 108 may include a network of computers and subnets (intranets) or both, and incorporate protocols, such as Internet Protocol (IP), Transmission Control Protocol (TCP), User Datagram Protocol (UDP), and/or the like.

The RANs 102A and 102B communicate with the UEs 114 to enable the UEs 114 to operate and/or communicate in the communication system 100, or more specifically, to communicate with the core network 104, the PSTN 106, the internet 108, other networks 110, or any combination thereof. The RANs 102 and/or the core network 104 may be in direct or indirect communication with one or more other RANs (not shown), which may or may not be directly served by the core network 104, and may or may not employ the same radio access technology as RAN 102A, 102B, or both. The core network 104 may also serve as a gateway access between (i) the RANs 102 or UEs 114 or both, and (ii) other networks (such as the PSTN 106, the internet 108, and the other networks 110).

Each RAN 102 comprises one or more base stations 112 and is configured to wirelessly connect with one or more UEs 114 to enable access to any other base stations 112, the core network 104, the PSTN 106, the internet 108, and/or the other networks 110. Herein, the base stations 112 and the UEs 114 may be considered as different types of network nodes (or simply “nodes”) of the communication system 100. A base station 112 forms part of the RAN 102, which may include other base stations 112, base station controllers (BSCs), radio network controllers (RNCs), relay nodes, elements, and/or devices. A base station 112 may comprise or may be a device in any suitable form such as a base transceiver station (BTS), a Node-B (NodeB), an evolved NodeB (eNodeB), a Home eNodeB, a gNodeB or gNB (next generation NodeB, sometimes called a “gigabit” NodeB), a transmission point (TP), a transmit/receive point (TRP), a site controller, an access point (AP), a wireless router, or the like. A base station 112 may otherwise be referred to herein as a node of a radio access network (RAN) or a RAN node. Moreover, a base station 112 may be a single element, as shown in FIG. 1, or comprise a plurality of elements distributed in a corresponding RAN 102. Each base station 112 transmits and/or receives wireless signals within a particular geographic region or area, sometimes referred to as a “cell” or “coverage area”. A cell may be further divided into cell sectors, and a base station 112 may, for example, employ a plurality of transmitters, receivers, and/or transceivers to provide service to multiple sectors. In some embodiments, there may be established pico or femto cells where the radio access technology supports such. In some embodiments, a plurality of transceivers may be used for each cell, for example using multiple-input multiple-output (MIMO) technology. The number of RANs 102 shown in FIG. 1 is exemplary only. Any number of RANs 102 may be contemplated when devising the communication system 100.

FIG. 2 is a simplified schematic diagram of a base station 112. As shown, the base station 112 comprises at least one processing unit or processor 142, at least one transmitter 144, at least one receiver 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the base station 112.

The processing unit 142 is configured for performing various processing operations such as signal coding, data processing, power control, input/output processing, or any other suitable functionalities. The processing unit 142 may comprise a microprocessor, a microcontroller, a digital signal processor, a field-programmable gate array (FPGA), an application-specific integrated circuit (ASIC), and/or the like. In some embodiments, the processing unit 142 may execute computer-executable instructions or code stored in the memory 150 to perform various processes (otherwise referred to as procedures) described below.

Each transmitter 144 may comprise any suitable structure for generating signals, such as control signals as described in detail below, for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 2 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the processes performed by a base station 112 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 1, the base stations 112 of the RANs 102 may communicate with the UEs 114 via Uu links 118 which may be any suitable wireless communication links such as radio frequency (RF) links, microwave links, infrared (IR) links, and/or the like. The UEs 114 may communicate with the base stations 112 via Uu links 118 using any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The Uu links 118 may use any suitable radio access technologies such as universal mobile telecommunication system (UMTS), high speed packet access (HSPA), HSPA+ (optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for GSM evolution (EDGE), GSM EDGE radio access network (GERAN), 5G New Radio (5G NR), standard or non-standard satellite internet access technologies, and/or the like. Herein, a communication from a RAN 102 or a base station 112 thereof to a UE 114 is denoted as a DL communication, and a communication from a UE 114 to a RAN 102 or a base station 112 thereof is denoted as an uplink (UL) communication. Accordingly, a channel used for a DL communication is a DL channel and a channel used for a UL communication is a UL channel.

Herein, the UEs 114 may be any suitable wireless device that may join the communication system 100 via a RAN 102 for wireless operation. In various embodiments, a UE 114 may be a wireless electronic device used by a human or user (such as a smartphone, a cellphone, a personal digital assistant (PDA), a laptop, a computer, a tablet, a smart watch, a consumer electronics device, and/or the like). A UE 114 may alternatively be a wireless sensor, an Internet-of-things (IoT) device, a robot, a shopping cart, a vehicle, a smart TV, a smart appliance, a wireless transmit/receive unit (WTRU), a mobile station, a fixed or mobile subscriber unit, a machine type communication (MTC) device, or the like. Depending on the implementation, the UE 114 may be movable autonomously or under the direct or remote control of a human, or may be positioned at a fixed position.

In some embodiments, a UE 114 may be a multimode wireless electronic device capable of operation according to multiple radio access technologies and incorporate multiple transceivers necessary to support such.

In addition, some or all of the UEs 114 comprise functionality for communicating with different wireless devices and/or wireless networks via different wireless links using different wireless technologies and/or protocols. Instead of wireless communication (or in addition thereto), the UEs 114 may communicate via wired communication channels to other devices or switches (not shown), and to the Internet 108. For example, as shown in FIG. 1, a plurality of the UEs 114 (such as UEs 114 in proximity with each other) may communicate with each other directly via suitable wired or wireless sidelinks 120. Accordingly, a wired or wireless channel of a wired or wireless sidelink 120 is denoted a sidelink channel. As will be described in more detail later, data transmissions via the sidelinks 120 may be scheduled or unscheduled in various embodiments.

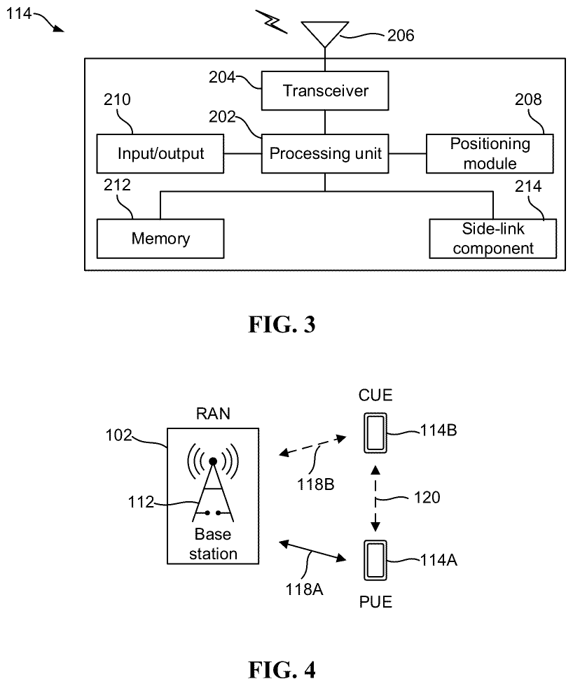

FIG. 3 is a simplified schematic diagram of a UE 114. As shown, the UE 114 comprises at least one processing unit or processor 202, at least one transceiver 204, at least one antenna or network interface controller (NIC) 206, at least one positioning module 208, one or more input/output components 210, at least one memory 212, and at least one sidelink component 214.

The processing unit 202 is configured for performing various processing operations such as signal coding, data processing, power control, input/output processing, or any other functionalities to enable the UE 114 to access and join the communication system 100 and operate therein. The processing unit 202 may also be configured to implement some or all of the functionalities of the UE 114 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with a RAN 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the UE 114. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the UE 114.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the UE 114 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one sidelink component 214 is configured for communicating with other devices such as other UEs 114 via suitable sidelinks 120. A wireless sidelink 120 may be a radio link, a WI-FI® (WI-FI is a registered trademark of Wi-Fi Alliance, Austin, TX, USA) link, a BLUETOOTH® link (BLUETOOTH is a registered trademark of Bluetooth Sig Inc., Kirkland, WA, USA), and/or the like. A wired sidelink 120 may be a connection established between two UEs 114 using a USB cable, a network cable, a parallel cable, a serial cable, and/or the like.

### B. Data Transmission, Scheduling, and UE Cooperation

After establishing connection with a base station 112 of a RAN 102, each UE 114 is assigned with a unique RNTI. Then, as shown in FIG. 4, a UE 114A may directly transmit data to the base station 112 or directly receive data from the base station 112 via the Uu link 118A therebetween. Thus, a data transmission goes through a direct path with one hop.

As is known in the art, the RAN 102 (or the base station 112 thereof) may transmit control signals, such as PDCCH signals, to UEs 114 connected thereto for scheduling data transmissions between the RAN 102 and UEs 114 (such as between the base station 112 of the RAN 102 and UE 114A), including scheduling downlink broadcast to all UEs 114 (for example, UEs 114A and 114B shown in FIG. 4) or scheduling unicast data transmission (downlink or uplink) between the RAN 102 and the UE 114A. The PDCCH signal carries downlink control information (DCI) which provides a scheduled resource allocation to a UE 114 for the UE 114 to use to transmit a physical downlink shared channel (PDSCH) or physical uplink shared channel (PUSCH) signal.

Data transmission between the RAN 102 and the UE 114A may also be performed by the PUE 114A (which may be a SUE transmitting data to the RAN 102 or a TUE receiving data transmitted by the RAN 102) and one or more CUEs 114B having sidelinks 120 therebetween. Such a data transmission goes through a path with two or more hops, and may be denoted as a cooperative data transmission.

For example, as shown in FIG. 4, for a cooperative UL data transmission from the PUE 114A (which is a SUE) to the RAN 102, the PUE 114A may transmit at least a portion of the data to be transmitted to the RAN 102 to the CUE 114B via the sidelink 120, and then the CUE 114B transmits the portion of the data received from the PUE 114A to the RAN 102 via the Uu link 118B. Similarly, for a cooperative DL data transmission from the RAN 102 to the PUE 114A, one or more base stations 112 of the RAN 102 may transmit at least a portion of the data to be transmitted to the PUE 114A to the CUE 114B via the Uu link 118B, and then the CUE 114B transmits the portion of the data received from the one or more base stations 112 of the RAN 102 to the PUE 114A via the sidelink 120.

As those skilled in the art will appreciate, cooperative data transmission may be useful when the Uu link 118A between the RAN 102 and the PUE 114A is of a low quality and/or a small bandwidth while the Uu link 118B between the RAN 102 and the CUE 114B is of high quality and/or a larger bandwidth, when a large amount of data needs to be transmitted between the RAN 102 and the PUE 114A, or when the PUE 114A is out of the wireless coverage area of the RAN 102 while CUE 114B is within the wireless coverage area of RAN 102.

As can be seen from FIG. 4, cooperative data transmission may involve data transmission via different links (for example, the Uu links 118A and 118B and the sidelink 120) and different paths (for example, Uu link 118B and the sidelink 120) between the RAN 102 (or one or more nodes or base stations 112 of the RAN 102), the PUE 114A (which may be a SUE or a TUE), and the CUE 114B.

Moreover, data transmissions between RANs 102 and UEs 114 may be scheduled by using control signals such as PDCCH signals transmitted by RANs 102 to UEs 114. In various embodiments, data transmissions via the sidelink 120 between two UEs 114 may be scheduled by the RAN 102 or unscheduled by the RAN 102 (in which case transmissions via the sidelink 120 between two UEs 114 may be scheduled by a device (for example, one of the two UEs 114) other than the RAN 102 or may be completely unscheduled or follow other communication protocols used either for a wireless sidelink or a wired sidelink such as Wi-Fi®, Bluetooth®, Ethernet, and/or the like).

In embodiments wherein transmissions via the Uu link 118 between the RAN 102 and UE 114 and transmissions via the sidelink 120 between two UEs 114A and 114B are scheduled by the RAN 102 (for example, in accordance with the 5G NR standard), a cooperative data transmission between the RAN 102 and the UE 114A via the UE 114B may be separately scheduled by transmitting control signals, such as PDCCH signals for unicast transmission, from the RAN 102 to the UEs 114A and 114B.

For example, a schedule for data transmission by the PUE 114A may be signaled by the base station (for example, gNB) 112 to the PUE 114A. The schedule may be signaled using dynamic signaling such as physical (PHY) layer signaling, or semi-static signaling which is a high-layer signaling. In these embodiments, signaling a schedule for a data transmission is mainly for a single data transmission between a transmitter (for example, a SUE 114A or a base station 112 such as a gNB) and a receiver (for example, a base station 112 such as a gNB or a TUE 114A) via a single link (such as the Uu link 118 or the sidelink 120).

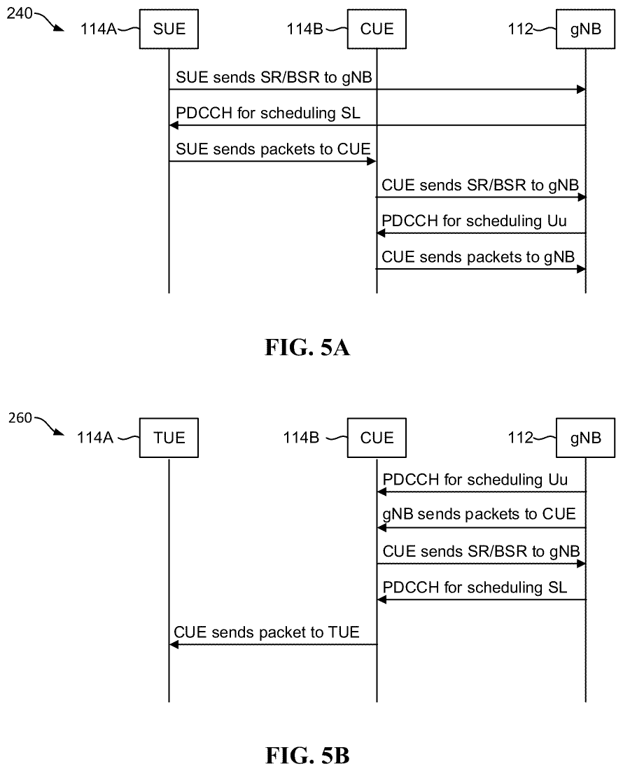

For example, FIG. 5A shows an example of cooperative UL data transmission 240 for transmitting data in one or more packets (wherein the payload of the one or more packets includes the transmitted data) from a PUE 114A (acting as a SUE) to a base station 112 (such as a gNB) of the RAN 102 via a CUE 114B as follows:
SUE 114A transmits a scheduling request (SR) and buffer status request (BSR) (SR/BSR) to base station (for example, gNB) 112 as described in the 3GPP standard;
base station (for example, gNB) 112 transmits a PDCCH signal to SUE 114A which carries scheduling information for data transmissions via sidelink 120;
SUE 114A transmits packets to CUE 114B via the sidelink 120 based on the received schedule;
After CUE 114B decodes the packets, CUE 114B transmits SR/BSR to the base station (for example, gNB) 112;
base station (for example, gNB) 112 transmits PDCCH signal to CUE 114B which carries a schedule for packet forwarding/relaying via the Uu link 118; and
CUE 114B transmits (for example, forwards/relays) packets to base station (for example, gNB) 112 via the Uu link 118.
FIG. 5B is a call flow diagram showing an example of cooperative UL data transmission 260 from a base station 112 (such as a gNB) of the RAN 102 to a PUE 114A (acting as a TUE) via a CUE 114B. As shown, the process 260 comprise the following steps:
base station (for example, gNB) 112 transmits PDCCH signal to CUE 114B;
base station (for example, gNB) 112 transmits packets to CUE 114B via Uu link 118;
CUE 114A sends SR/BSR to gNB 112;
base station (for example, gNB) 112 transmits PDCCH signal to CUE 114B which includes a schedule for packet transmissions via sidelink (SL) 120; and
CUE forwards/relays packets to TUE 114A via sidelink 120 based on the received schedule.

As can be seen in FIGS. 5A and 5B, the RAN 102 separately transmits a PDCCH signal to each UE 114 in a UE-cooperation group for scheduling data transmission of each UE 114. Therefore, scheduling the data transmissions using conventional PDCCH signals requires significant control signaling to be transmitted between the RAN 102 and the UEs 114, and thereby leading to increased data transmission latency and/or reduced efficiency of communication channel usage.

Moreover, the processes 240, 260 shown in FIGS. 5A and 5B do not distinguish between scheduling for cooperative data transmission (that is, packet relaying by CUE 114B between SUE 114A and base station (for example, gNB) 112) and scheduling for non-cooperative data transmission (that is, CUE 114B transmitting its own packets directly to base station (for example, gNB) 112 or receiving its own packets directly from base station (for example, gNB) 112). The identification of these packets are completed in an upper layer of a protocol stack of the CUE 114B (for example, a medium access control (MAC) layer or a Radio Resource Control (RRC) layer) which may delay packet forwarding/relaying (or UE cooperation/aggregation).

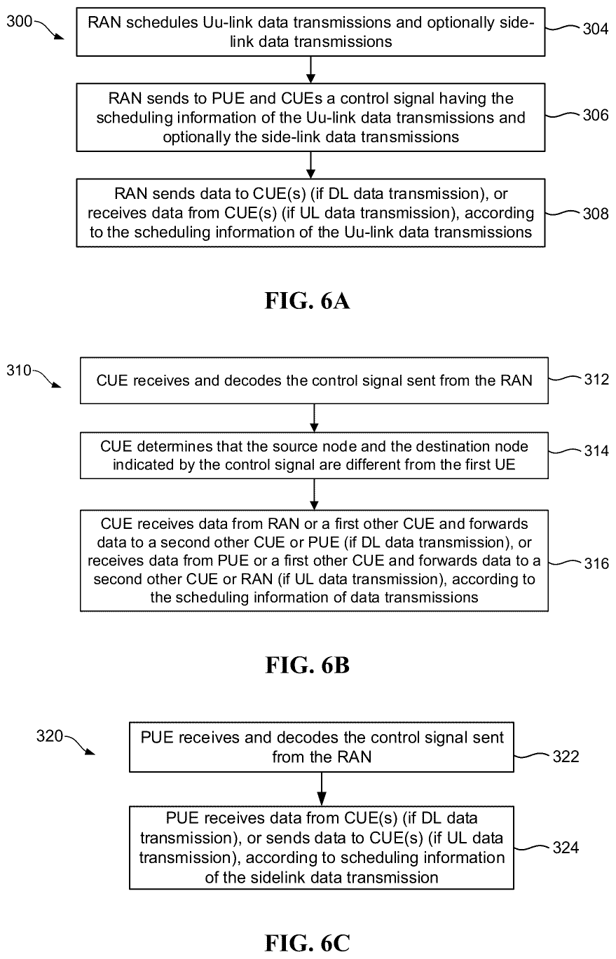

FIGS. 6A to 6C are flowcharts showing processes 300, 310, and 320 performed by a RAN 102, a PUE 114A, and one or more CUEs 114B, respectively, for cooperative data transmission between the RAN 102 and the PUE 114A via the one or more CUEs 114B using a group-based scheduling.

FIG. 6A shows the process 300 performed by the RAN 102.

At step 304, the RAN 102 schedules data transmissions via the Uu link 118 and optionally (for example, if any sidelink 120 between the PUE 114A and CUEs 114B can be scheduled) data transmissions via one or more sidelinks 120 between the PUE 114A and a CUE 114B and/or between two CUEs 114B.

At step 306, the RAN 102 sends to the group of the PUE 114A and the one or more CUEs 114B a control signal carrying the scheduling information for the Uu-link data transmissions and sidelink data transmissions.

If the cooperative data transmission is a cooperative DL data transmission, the RAN 102 transmits data to one or more CUEs 114B via one or more Uu links 120 therebetween according to the corresponding Uu-link data transmission schedules (step 308). The RAN 102 may also directly transmit data to the PUE 114A as part of the cooperative DL data transmission via the Uu link 120 therebetween according to the corresponding Uu-link data transmission schedule.

If the cooperative data transmission is a cooperative UL data transmission, the RAN 102 receives data from one or more CUEs 114B via one or more Uu links 120 therebetween according to the scheduling information which includes information for scheduling Uu-link data transmissions (step 308). The RAN 102 may also directly receive data from the PUE 114A as part of the cooperative UL data transmission via the Uu link 120 therebetween according to the scheduling information which includes information of Uu-link data transmissions. Then, the RAN 102 combines data received from the one or more CUEs 114B and the PUE 114A.

FIG. 6B shows the processes 310 performed by a CUE 114B.

At step 312, the CUE 114B receives and decodes the control signal transmitted by the RAN 102.

At step 314, the CUE determines that it is not the source node nor the destination node indicated by the scheduling information carried in the control signal, thereby confirming that upcoming data transmissions are part of a cooperative data transmission.

If the cooperative data transmission is a cooperative DL data transmission, the CUE 114B receives data from the RAN 102 (via the Uu link 120 therebetween according to the corresponding Uu-link data transmission schedule) or a first other CUE (via the sidelink 118 therebetween according to the corresponding sidelink data transmission schedule), and forwards the data to a second other CUE or the PUE 114A (via the sidelink 118 therebetween according to the corresponding sidelink data transmission schedule) (step 316).

If the cooperative data transmission is a cooperative UL data transmission, the CUE 114B receives data from the PUE 114A or a first other CUE (via the sidelink 118 therebetween according to the corresponding sidelink data transmission schedule), and forwards the data to a second other CUE (via the sidelink 118 therebetween according to the corresponding sidelink data transmission schedule) or the RAN 102 (via the Uu link 120 therebetween according to the corresponding Uu-link data transmission schedule) (step 316).

FIG. 6C shows the process 320 performed by the PUE 114A.

At step 322, the PUE 114A receives and decodes the control signal transmitted by the RAN 102 (for example, one or more base stations 112 of the RAN 102).

If the cooperative data transmission is a cooperative DL data transmission, the PUE 114A receives data from one or more CUEs via one or more sidelinks therebetween according to the corresponding sidelink data transmission schedules (step 324). The PUE 114A may also directly receive data from the RAN 102 as part of the cooperative DL data transmission via the Uu link 120 therebetween according to the corresponding Uu-link data transmission schedule. Then, the PUE 114A combines data received from the one or more CUEs 114B and the RAN 102.

If the cooperative data transmission is a cooperative UL data transmission, the PUE 114A sends data to one or more CUEs via one or more sidelinks therebetween according to the corresponding sidelink data transmission schedules (step 324).

Thus, a cooperative data transmission is a data transmission ultimately between the RAN 102 and the PUE 114A but going through at least one CUE 114B. A cooperative data transmission may comprise one or more data transmissions via Uu links 118 between the RAN 102 and one or more CUEs 114B, one or more data transmissions via sidelinks 120 (“sidelink data transmissions”) between a plurality of CUEs 114B (if more than one CUEs 114B are involved), one or more sidelink-data transmission via sidelinks 120 between the PUE 114A and one or more CUEs 114B, and, in some embodiments, a data transmission via the Uu link 118 between the RAN 102 and the PUE 114A. The transmissions via Uu links 118 are generally scheduled by the RAN 102. The sidelink-data transmissions via sidelinks 120 may be scheduled by the RAN 102 in some embodiments, and may not be scheduled by the RAN 102 in some other embodiments.

In these embodiments, the UEs 114 (including the PUE 114A and the one or more CUEs 114B) are UEs that may directly communicate via sidelinks 120 such as UEs adjacent to each other and with a suitable D2D communication means via the sidelinks 120. Moreover, the UEs 114 of a UE-cooperation group involved in cooperative data transmissions may be determined by the RAN 102 based on, for example, the positioning information of the UEs 114 determined by the RAN 102. Alternatively, the UEs 114 of a UE-cooperation group involved in the cooperative data transmissions may be determined by one or more of the UEs 114 based on D2D position sensing technologies (for example, by measuring the received signal strength (RSS) of other UEs) or based on other suitable means such as direct wired connections (that is, if two UEs 114 are directly connected via a wired connection, they can be part of the UE-cooperation group that is involved in cooperative data transmissions). One or more of above alternatives may also be used together. The identities of the determined UEs 114 (such as the RNTIs thereof) are transmitted to the RAN 102.

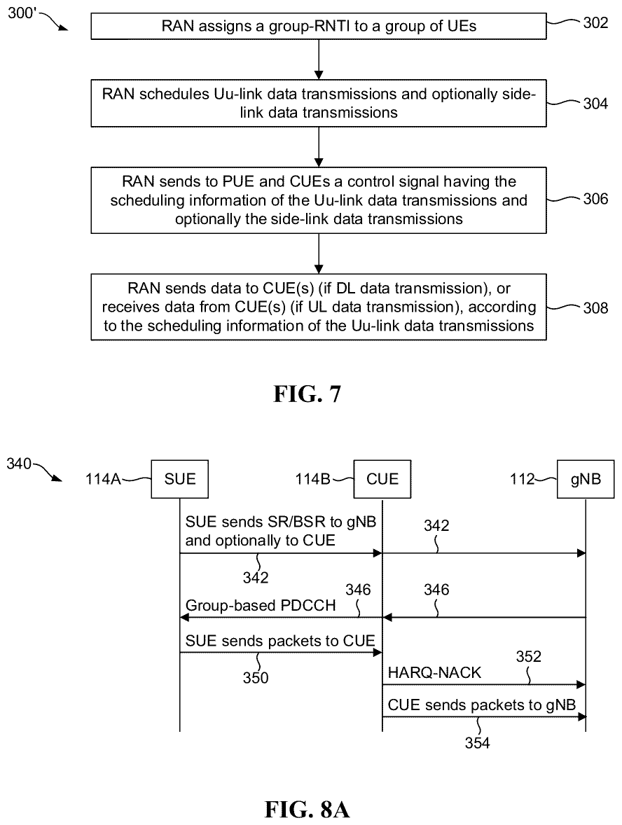

FIG. 7 shows the process 300′ performed by the RAN 102 according some alternative embodiments of this disclosure.

As shown, after determining the UEs 114 for cooperative data transmission, the RAN 102 assigns a group-ID (also denoted as “group-based ID”) such as a group-RNTI to the determined UEs 114 to form a UE-cooperation group while each UE 114 in the UE group still maintains its own unique RNTI (step 302). Then, the UEs 114 (which may become PUE 114A (that is, SUE or TUE) and CUE 114B) in the UE-cooperation group may try to monitor and decode group-based control signals (that is, control signals scrambled by the group-ID) such as PDCCH signals scrambled by the group-RNTI (denoted “group-based PDCCH signals” or “group-specific PDCCH signal” hereinafter).

The process 300 then proceeds to steps 304 to 308 which are the same as those shown in FIG. 6A.

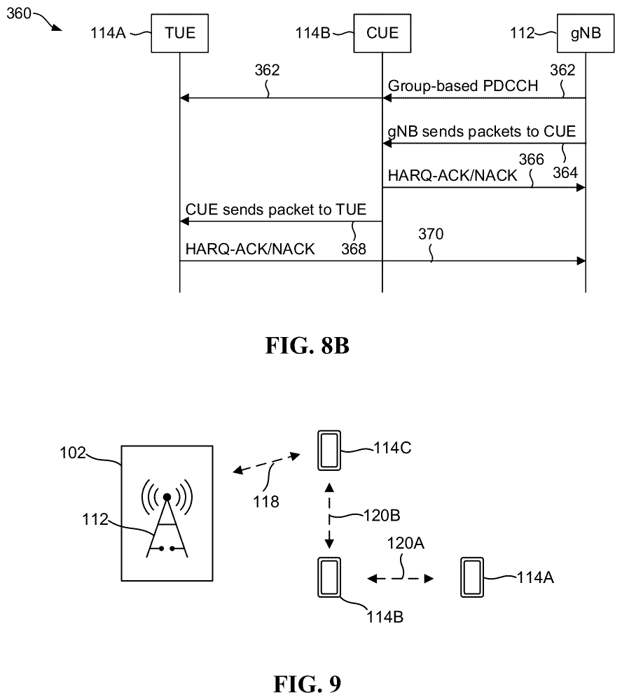

FIG. 8A is a call flow diagram showing an example of cooperative UL data transmission from the PUE 114A to the RAN 102 via the CUE 114B (for example, cooperative UL data transmission along the dashed arrows 118B and 120 shown in FIG. 4).

The SUE 114A sends SR/BSR 342 to a base station (for example, gNB) 112 of the RAN 102. The SR/BSR 342 may also be sent to the CUE 114B to trigger the CUE 114B to start searching for group-based PDCCH signal.

Then, the a base station (for example, gNB) 112 of the RAN 102 sends one or more group-based PDCCH signals 346 carrying scheduling information for data transmissions via the Uu link 118B and the sidelink 120 (see FIG. 4). Both the SUE 114A and the CUE 114B receive and decode the group-based PDCCH signal to obtain the scheduling information carried in the group-based PDCCH signal.

After decoding the group-based PDCCH signal, the SUE 114A transmits packets 350 to the RAN 102 via the CUE 114B based on the scheduling information. In the situation that data transmissions via the sidelink 120 between the SUE 114A and the CUE 114B are not scheduled by the RAN 102 (for example, unspecified link by the 3GPP standard), the SUE 114A may transmit packets 350 according to the transport block size (TBS; which defines how many bits the MAC layer transfers to the physical layer per Transmission Time Interval (TTI, defined as one (1) millisecond (ms))) in the scheduling information carried in group-based PDCCH signal 346 via the sidelink 120 (following any suitable protocol used for transmissions via the sidelink 120). Optionally, the SUE 114A may transmit to the CUE 114B side information such as TBS, Hybrid Automatic Repeat Request (HARQ) ID and RV of the packet along with the packet for verification purposes. Meanwhile, the CUE 114B monitors the sidelink 120 for packets transmitted by the SUE 114A after decoding the group-based PDCCH signal. The packet transmitted by the SUE 114A via the sidelink 120 may be received earlier than CUE 114B detects its group-based PDCCH.

If the CUE 114B fails to decode the packets transmitted by the SUE 114A via the sidelink 120 (for example, failed to receive and decode the packets within a time window after the CUE 114B receives the group-based PDCCH), the CUE 114B may send a HARQ-NACK 352 (a signal representing negative acknowledgment or not acknowledged) to the base station (for example, gNB) 112 of the RAN 102, and the base station (for example, gNB) 112 may release the allocated resource (such as time slots and frequency bands allocation for the data transmission) on the Uu link 118 (if the resource is scheduled) and arrange re-transmission (from the SUE 114A).

If the CUE 114B successfully receives and decodes the packets from the SUE 114A, the CUE 114B transmits the received packets 354 to the base station (for example, gNB) 112 of the RAN 102 via the Uu link 118 using the scheduling information carried in the group-based PDCCH signal. Optionally the CUE 114B may check the side information for decoded packet on TBS and optionally HARQ ID and RV to verify against the corresponding information included in the received scheduling information carried in the group-based PDCCH and only transmit the packets to the base station (for example, gNB 112) of the RAN 102 if the side information matches the corresponding information, so as to make sure that the right packet is relayed. If the side information does not match the corresponding information, the CUE 114B may send a HARQ-NACK instead. In other words, only one of transmitting the HARQ-NACK 352 and transmitting the received packets 354 in FIG. 8A may occur.

The cooperative UL data transmission and reception is then completed.

FIG. 8B is a call flow diagram showing an example of cooperative DL data transmission from the RAN 102 to the PUE 114A via the CUE 114B (for example, cooperative DL data transmission along the dashed arrows 118B and 120 shown in FIG. 4).

The base station (for example, gNB) 112 of the RAN 102 transmits a group-based PDCCH signal 362 carrying scheduling information for Uu-link transmission 118B and sidelink transmission 120 (see FIG. 4). Both the TUE 114A and the CUE 114B receive and decode the group-based PDCCH signal 362 to obtain the scheduling information carried in the group-based PDCCH.

After decoding the group-based PDCCH signal, the CUE 114B monitors the Uu link 118 for packets from the base station (for example, gNB) 112 of the RAN 102. Optionally, the TUE 114A may monitor the sidelink 120 for packets from the CUE 114B.

The base station (for example, gNB) 112 of the RAN 102 then transmits packets 364 to the CUE 114B according to the scheduling information carried in the group-based PDCCH signal 362 via the Uu link 118 for the CUE 114B to relay the packets to the TUE 114A.

If the CUE 114B fails to decode the packets transmitted by the base station (e.g gNB) 112 of the RAN 102 via the Uu link 118 (for example, failed to receive and decode the packets within a time window), the CUE 114B may send a HARQ-NACK 366 to the base station (e.g gNB) 112 of the RAN 102, and the base station (e.g gNB 112) may release the allocated resource on the sidelink 120 (if the resource is scheduled) and arrange re-transmission via the Uu link 118.

If the CUE 114B successfully receives and decodes the packets transmitted by the base station (for example, gNB) 112 of the RAN 102, the CUE 114B may optionally send a HARQ-ACK (Hybrid Automatic Repeat Request-Acknowledgement) 366 to the base station (for example, gNB) 112 of the RAN 102. Moreover, the CUE 114B transmits the received packets 368 to the TUE 114A via the sidelink 120 using the scheduling information carried in the group-based PDCCH signal. If the sidelink 120 is an unscheduled link (for example, an unspecified link as defined in the 3GPP), the CUE 114B may transmit the received packets 368 via the sidelink 120 following any suitable protocol. After the TUE 114A decodes the group-based PDCCH, the TUE 114A may optionally monitor the sidelink 120 for relayed packet transmitted by the CUE 114B.

If the TUE 114A successfully receives and decodes the packets received from the CUE 114B via the sidelink 120, the TUE 114A may send a HARQ-ACK 370 to the base station (for example, gNB) 112; otherwise, the TUE 114A may send a HARQ-NACK (Hybrid Automatic Repeat Request-Negative Acknowledgement) to the base station (for example, gNB) 112 and the base station (for example, gNB) 112 may schedule re-transmission.

The cooperative DL data transmission and reception is then completed.

In an alternative embodiment, the CUE 114B may not send any HARQ-ACK/NACK to the base station (for example, gNB) 112, and the TUE 114A may send the HARQ-ACK/NACK to the base station (for example, gNB) 112 to indicate the success or failure of the cooperative DL data transmission and reception.

FIG. 9 shows an example of cooperative data transmission between a PUE 114A and a RAN 102 (that is, transmitting data from the PUE 114A to the RAN 102 or transmitting data from the RAN 102 to the PUE 114A) using two CUEs 114B and 114C via sidelink 120A between the PUE 114A and the CUE 114B, a sidelink 120B between the CUE 114B and the CUE 114C, and a Uu link 118 between the RAN 102 and the CUE 114C. In this example, the RAN 102 may send a group-based PDCCH signal having scheduling information for the Uu link 118 and the sidelinks 120A and 120B for cooperative data transmission.

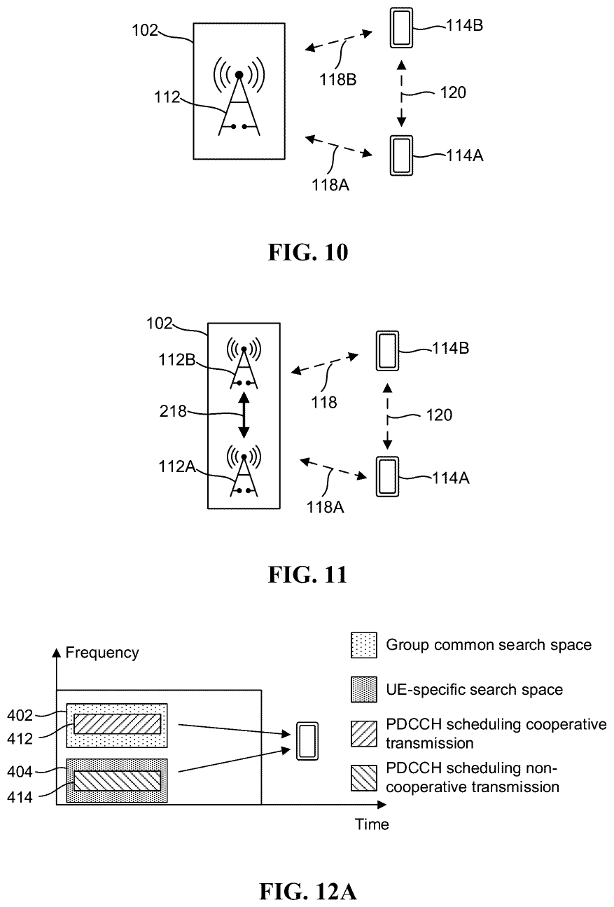

FIG. 10 shows another example of cooperative data transmission between a PUE 114A and a RAN 102 (that is, transmitting data from the PUE 114A to the RAN 102 or transmitting data from the RAN 102 to the PUE 114A) using a CUE 114B. In this example, a portion of the data is directly transmitted between the PUE 114A and the RAN 102 directly via the Uu link 118A, and the rest of the data may be indirectly transmitted between the PUE 114A and the RAN 102 through the CUE 114B via the Uu link 118B between the RAN 102 and the CUE 114B and the sidelink 120 between the PUE 114A and the CUE 114B. In this example, the RAN 102 may transmit a group-based PDCCH signal carrying scheduling information for data transmission via the Uu links 118A and 118B and the sidelinks 120.

FIG. 11 shows yet another example of cooperative data transmissions between the PUE 114A and the RAN 102 (that is, transmitting data from the PUE 114A to the RAN 102 or transmitting data from the RAN 102 to the PUE 114A) via two RAN nodes or base stations (for example, gNBs) 112A and 112B of the RAN 102, and a CUE 114B.

For cooperative UL data transmission from the PUE 114A to the base station (for example, gNB) 112A, the PUE 114A may transmit a portion of the data directly to the base station (for example, gNB) 112A and transmit the other portion of the data to be transmitted to the base station (for example, gNB) 112A to the CUE 114B via the sidelink 120 therebetween, and the CUE 114B transmits the received data to the base station (for example, gNB) 112B via the Uu link 118B therebetween. Then, the base station (for example, gNB) 112B transmits the received data to the base station (for example, gNB) 112A via a link 218 therebetween, and the base station (for example, gNB) 112A combines the two portions to form the complete data.

Similarly, for a cooperative DL data transmission from the base station (for example, gNB) 112A to the PUE 114A, the base station (for example, gNB) 112A may send at least a portion of the data to be transmitted to the PUE 114A to the base station (for example, gNB) 112B via the link 218 therebetween, and the base station (for example, gNB) 112B sends the received data to the CUE 114B via the Uu link 118B therebetween. Then, the CUE 114B transmits the received data to the PUE 114A via the sidelink 120 therebetween.

In this example, the RAN 102 may send a group-based PDCCH signal carrying scheduling information for the Uu links 118A and 118B and the sidelink 120 for collaborative data transmission.

By using the group-based scheduling and the group-based control signals such as group-based PDCCH signals, the RAN 102 avoids the requirement of separately transmitting a PDCCH signal to each UE 114 involved in UE cooperation for scheduling the UE's data transmission. With the reduced control signaling transmission between the RAN 102 and the UEs 114, UE cooperation for cooperative data transmission and reception gives rise to improved effectiveness and/or improved efficiency.

### C. Group-Based Pdcch Signal

In conventional RANs, a DL radio frame comprises a control resource (or a control resource set (CORSET)) region for transmitting a PDCCH signal, and a control resource region comprises a plurality of time and/or frequency locations for transmitting PDCCH signals (or simply PDCCHs). A possible location for PDCCH is denoted a PDCCH candidate and a group of possible locations is denoted a search space (or a search space set). A common search space is used for transmitting a common PDCCH (that is, PDCCH broadcast to all UEs), and a UE-specific search space is used for transmitting UE-specific PDCCH to a specific UE. Therefore, a UE may search the common search space and/or its UE-specific search space to find the common PDCCH or a UE-specific PDCCH.

Similar to conventional RANs, the RAN 102 in some embodiments may define a group common search space determined by the group-RNTI for transmitting group-based PDCCH wherein the group-based PDCCH is scrambled and/or CRC-masked (-scrambled) by the group-RNTI (described in more detail later). UE group-ID (local UE identifier (ID) in the group) may be used for bit-level scrambling group-based PDCCH in addition to CRC-scrambling of group-based PDCCH.

In these embodiments, the conventional UE-specific search space is still used to transmit the conventional UE-specific PDCCH (that is, the conventional PDCCH for unicast transmission).

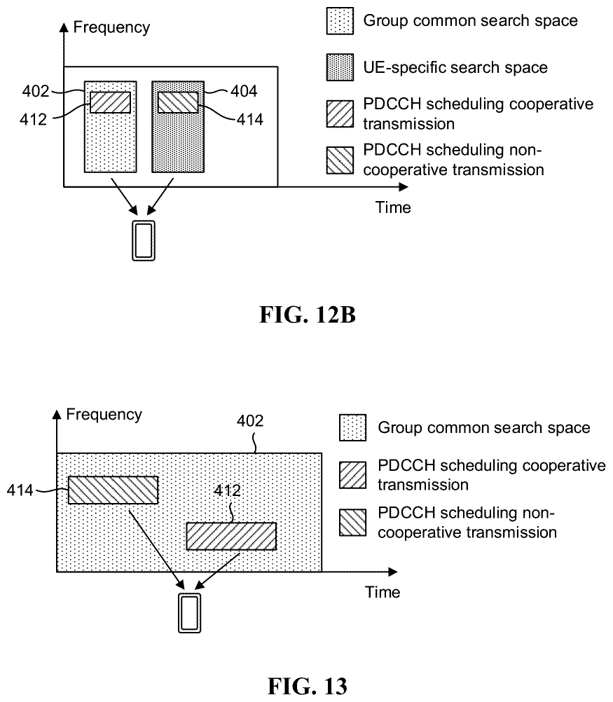

FIG. 12A is a graph showing a group common search space and a UE-specific search space, according to some embodiments of this disclosure. As shown, a group common search space 402 may be configured to transmit a group-based PDCCH 412 and a UE-specific search space 404 may be configured to transmit a UE-specific PDCCH 414. The group common search space 402 and the UE-specific search space 404 may be arranged in different frequency bands. Accordingly, the UE 114 may be configured with respective number of blind decodings (BD) of the PDCCH payload to be performed among these two search spaces 402 and 404 to retrieve control information related to the downlink shared channel.

FIG. 12B is a graph showing a group common search space and a UE-specific search space, according to some other embodiments of this disclosure. As shown, a group common search space 402 may be configured to transmit a group-based PDCCH 412, and a UE-specific search space 404 may be configured to transmit a UE-specific PDCCH 414. The group common search space 402 and the UE-specific search space 404 may be arranged in different time slots.

With the use of the group common search space 402 and the UE-specific search space 404, the UE 114 monitors the group common search space 402 for a group-based PDCCH that carries the scheduling information for cooperative data transmission. The UE 114 also monitors UE-specific search space 404 for a UE-specific PDCCH that carries the scheduling information for conventional direct transmission (that is, non-cooperative data transmission).

In some embodiments, the group common search space 402 may be configured in a CORSET region associated with the conventional common search space. In some other embodiments, the group common search space 402 may be configured in a CORSET region associated with the UE-specific search space. In some other embodiments, the UE-specific search space 404 of the PUE 114A may be configured as the group common search space. In general, the group common search space may be considered a UE-specific search space accessible and shared by a group of UEs rather than a UE-specific search space used only by an individual UE. The group common search space may be configured together with or separately from the UE-specific search space and may have overlapping with an UE-specific search space, a common search space, or another group common search space.

In above embodiments, the PUE and CUEs in a UE cooperation or UE aggregation may perform both the conventional non-cooperative data transmission and the cooperative data transmission depending on whether a group-based PDCCHs are received.

In some alterative embodiments, the UEs 114 may be configured with a UE cooperation/aggregation mode which may be enabled by suitable signaling from the RAN 102 (for example, after receiving the group-ID such as the group-RNTI). When the UEs 114 are not in cooperation/aggregation mode, the UEs 114 may perform the conventional non-cooperative data transmission (and not be able to perform the cooperative data transmission). When the cooperation/aggregation mode is enabled, the UEs 114 may act as PUE and CUE and perform cooperative data transmission as well as the conventional non-cooperative data transmission in a more unified manner. For example, the PUE 114A and CUE 114B may stop monitoring their respective UE-specific search space for the PDCCH scheduling of conventional non-cooperative data transmission, and instead only monitor the group common search space for both group-based PDCCH scheduling of cooperative data transmission and UE-specific PDCCH scheduling of conventional non-cooperative data transmission. The UE 114 (which may be the PUE 114A or CUE 114B) may distinguish these two types of PDCCH by different CRC-scrambling, one by at least the group-based RNTI and the other by conventional UE-specific RNTI. By doing this, the UE 114 does not need to monitor both UE-specific search space and group common search space while supporting both cooperative data transmissions and conventional non-cooperative data transmission.

For example, as shown in FIG. 13, the group common search space 402 may be configured to transmit both a group-based PDCCH 412 and a UE-specific PDCCH 414. As described above, the group common search space is determined by the group-RNTI and some UE-specific IDs may be used to determine UE-specific PDCCH candidates for different UEs 114. The group-based PDCCH carries scheduling information for cooperative data transmission and is scrambled and/or CRC-masked by the group-RNTI. The UE-specific PDCCH of a UE 114 carries scheduling information for non-cooperative data transmission and is scrambled and/or CRC-masked by the UE-specific RNTI of the UE.

In these embodiments, a UE 114 may be configured to monitor the group common search space 402 only. As the UE-specific PDCCH is in the group common search space 402, the UE 114 does not need to monitor the UE-specific search space 404 for conventional non-cooperative PDCCH.

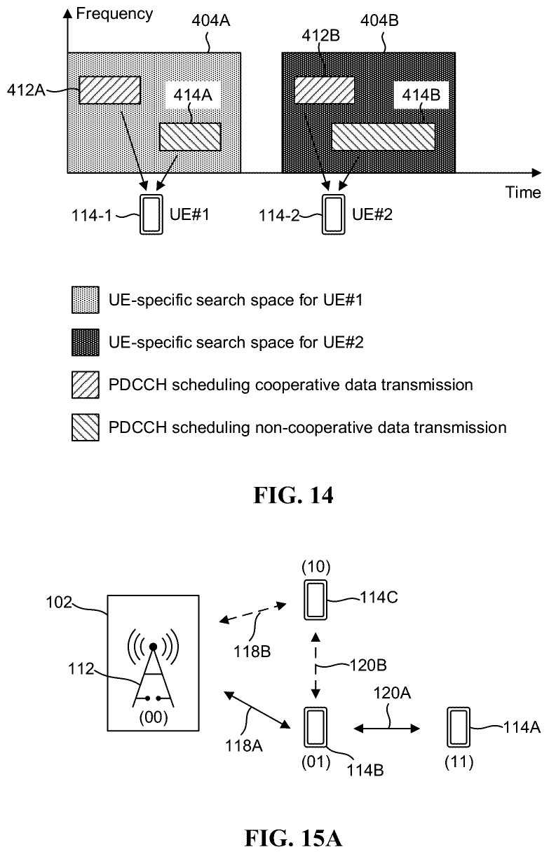

In some embodiments, a UE-specific search space 404 may be configured to transmit both the UE-specific PDCCH and the group-based PDCCH. For example, as shown in FIG. 14, a UE-specific search space 404A for a first UE 114-1 may be used for transmitting a group-based PDCCH 412A for scheduling cooperative data transmission involving the first UE 114-1 and a conventional UE-specific PDCCH 414A for scheduling non-cooperative data transmission for the first UE 114-1. A UE-specific search space 404B for a second UE 114-2 may be used for transmitting a group-based PDCCH 412B for scheduling cooperative data transmission involving the second UE 114-2, and a conventional UE-specific PDCCH 414B for scheduling non-cooperative data transmission for the second UE 114-2. In these embodiments, the UEs 114-1 and 114-2 are configured to monitor both the conventional UE-specific PDCCH (that is, conventional PDCCH unicast) and the group-based PDCCH in UE-specific search spaces.

With the uses of the group-based PDCCH and group common search space, the above-described embodiments allow UEs 114 to effectively and efficiently participate in cooperative data transmission/reception. A RAN 102 may transmit group-based PDCCH in group common search space or UE-specific search space to schedule cooperative data transmission/reception. The group-based PDCCH may be scrambled and/or CRC-masked by the group-RNTI and other parameters. Therefore, UEs 114 in UE cooperation/aggregation may readily differentiate the group-based PDCCH from the conventional UE-specific PDCCH.

In some embodiments, the group-based control signal such as the group-based PDCCH may contain one or more scheduling incidents for one or more cooperative data transmissions/receptions.

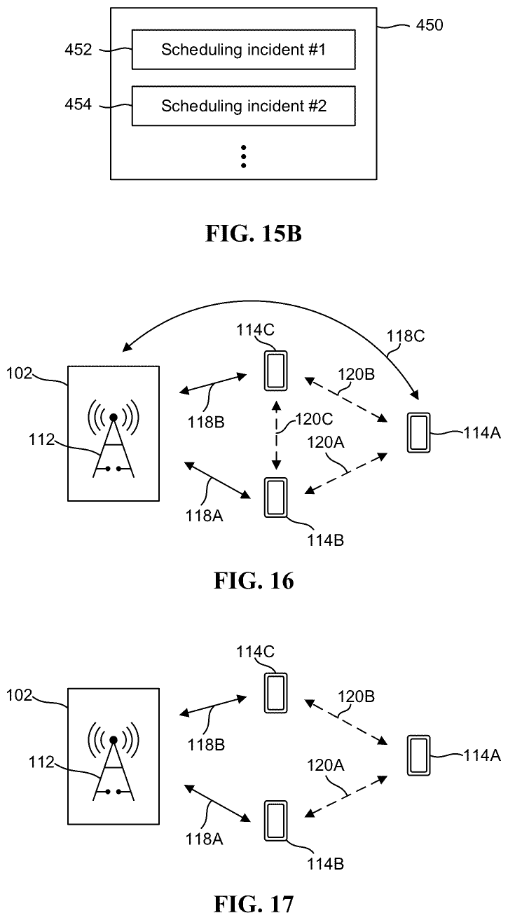

For example, FIG. 15A shows a RAN 102 and three UEs 114A to 114C of a UE-cooperation group performing two cooperative data transmissions and/or cooperative data receptions. The first cooperative data transmission will occur for transmitting data from the UE 114A (acting as a SUE) through the UE 114B (acting as a CUE) to the RAN 102, and the second cooperative data transmission will occur for transmitting data from the UE 114B (acting as a SUE) through the UE 114C (acting as a CUE) to the RAN 102.

As shown in FIG. 15B, one or more base stations (for example, gNBs) 112 of the RAN 102 may send a group-based PDCCH 450 carrying scheduling information for the two scheduling incidents 452 and 454. In some embodiments, the scheduling information for each scheduling incident 452 and 454 may comprise:
An indication of a transmitting node (UE 114 or base station (for example, gNB) 112) of the packet;
An indication of a receiving node (UE 114 or base station (for example, gNB) 112) of the packet;
An indication of the source node of the packet (optional);
An indication of the destination node of the packet (optional);
TBS;
Resource allocation for the data transmission via the Uu link, the sidelink, or both (such as time slots and frequency bands, and starting timing);
HARQ process ID;
Redundancy version (RV);
ACK/NACK resource (in Physical uplink control channel (PUCCH)).

Herein, an indication of a node may be an ID (such as the RNTI) of the node.

A UE group-ID or local UE ID (with a length much shorter than that of the RTNI) may be assigned to each UE 114 (that is, PUE and CUEs) in the UE-cooperation group and may be used as the ID in the DCI to identify each UE in the group. The base station (for example, gNB) 112 or the PUE 114 may be assigned with a UE group-ID or a local UE ID as well. In general, UE group-IDs or local UE IDs are local UE identifications different from RNTIs (which are assigned to identify UEs within a group or in the neighborhood or associated with each other in some manners (for example, D2D, relaying)).

For example, a 2-bit field may be used for the local UE ID for a group of four members (including gNB and UEs). In the example shown in FIG. 15A, the base station (for example, gNB) 112 in the UE-cooperation group may be assigned with a local UE ID of “00”, the UE 114B may be assigned with a local UE ID of “01”, the UE 114C may be assigned with a local UE ID of “10”, and the UE 114A may be assigned with a local UE ID of “11”.

The embodiments described in this section use a general-format group-based PDCCH carrying scheduling information for cooperative data transmission within a UE-cooperation group of. The scheduling information carried in the group-based PDCCH may include one or more scheduling incidents for one or more cooperative data transmissions.

FIG. 16 shows a cooperative data transmissions in some embodiments. In these embodiments, the sidelinks 120A, 120B, and 120C between UEs 114A, 114B, and 114C of a UE-cooperation group are unscheduled sidelinks (for example, when the sidelinks use wired or wireless communication technologies such as non-3GPP technologies such as WI-FI®, BLUETOOTH®, Ethernet, direct wired connection, and/or the like). Therefore, the RAN 102 in these embodiments only schedules data transmissions via the Uu links 118A, 118B, and 118C, and does not schedule data transmissions via the sidelinks 120A, 120B, and 120C.

In some embodiments as shown in FIG. 17, a PUE 114A uses one of two CUEs 114C and 114C for cooperative data transmission between the RAN 102 and the PUE 114A. The RAN 102 only schedules cooperative data transmissions via the Uu links 118A and 118B, and does not schedule data transmissions via the sidelinks 120A and 120B.

In these embodiments, the group-based PDCCH may contain information to indicate which one of the CUEs 114B and 114C is used for data transmission and/or data reception between the RAN 102 and the PUE 114A via the Uu links 118A, 118B.

In one embodiment, an explicit bit-field may be included in a DCI which includes the scheduling information and the bit-field may indicate which one of the CUEs 114B and 114C is scheduled for cooperative UL or DL data transmission. For example, a 2-bit bit-field may be included in DCI where the binary number “00” represents CUE 114B and the binary number “01” represents CUE 114C.

In another embodiment, the PDCCH may be scrambled and/or CRC-masked by one parameter or a combination of a plurality of parameters (such as the combination of the group-RNTI, UE-specific ID (for example UE-specific RNTI or local UE ID or UE group-ID), and/or the like) as implicit indication of the CUE (being CUE 114B or 114C) and PUE 114A being scheduled. For example, the PDCCH carrying scheduling information for cooperative data transmission via CUE 114B may be CRC-masked and/or scrambled by a combination of a plurality of the parameters of local UE ID of CUE 114B, group-RNTI, and UE-specific RNTI of UE 114B. As another example, the PDCCH carrying scheduling information for cooperative data transmission via CUE 114C may be CRC-masked and/or scrambled by a combination the parameters of local UE ID of CUE 114C, group-RNTI, and UE-specific RNTI of UE 114C.

In yet another embodiment, the group-based PDCCH may carry scheduling information that contains a bit-field to indicate which CUE is being scheduled and the PDCCH is also scrambled and/or CRC-masked by group-RNTI or UE group-ID.

In some embodiments, the group-based PDCCH may carry the following scheduling information:
bit-field to indicate the CUE that is scheduled (optional);
TBS;
resource allocation for the data transmission via Uu link by the CUE (such as time slots and frequency bands);
indication of the transmission time of scheduled packet (from the CUE) for UL;
HARQ process ID;
RV;
HARQ-ACK/NACK resource (the HARQ-ACK/NACK resource on PUCCH may differ for CUE and PUE).

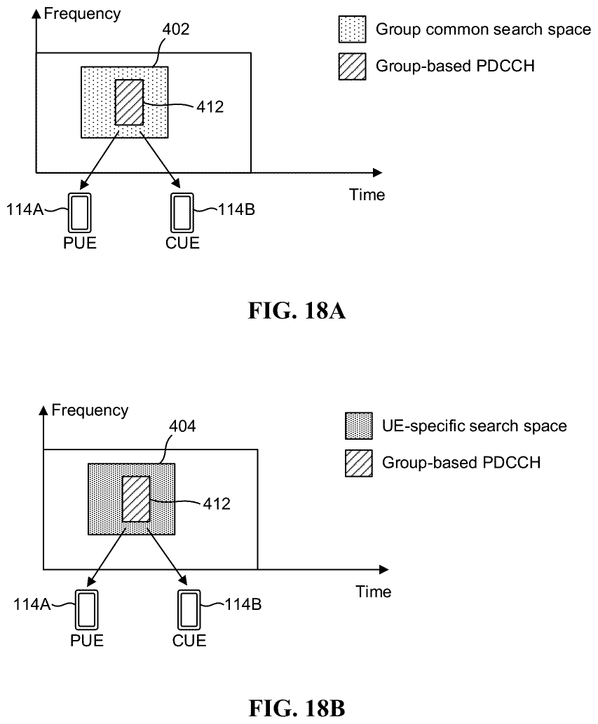

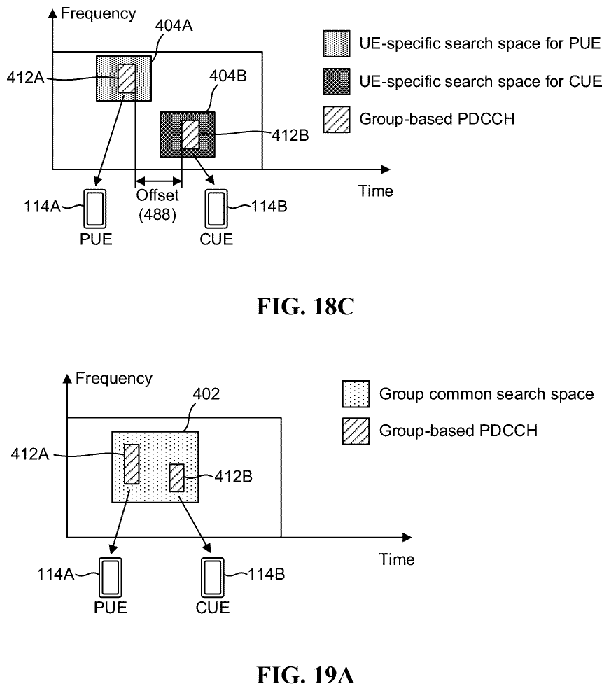

As shown in FIG. 18A, in some embodiments, the group-based PDCCH 412 may be transmitted in a group common search space 402 such that the group-based PDCCH 412 may be decoded by the PUE 114A and CUE 114B.

In some alternative embodiments as shown in FIG. 18B, the group-based PDCCH 412 may be transmitted in a UE-specific search space 404 such as the UE-specific search space of the PUE 114A such that the group-based PDCCH 412 may be decoded by both the PUE 114A and the CUE 114B (if the group-based PDCCH 412 is CRC scrambled by group-RNTI only).

In some alternative embodiments as shown in FIG. 18C, the UE-specific search space 404A of the PUE 114A and the UE-specific search space 404B of the CUE 114B may each transmit a same copy of the group-based PDCCH 412 (identified as 412A and 412B) such that the PUE 114A may find and decode the group-based PDCCH 412 from its UE-specific search space 404A, and the CUE 114B may find and decode the group-based PDCCH 412 from the CUE's UE-specific search space 404B.

Alternatively, the group-based PDCCH 412B transmitted in the UE-specific search space 404B of the CUE 114B may be a group-based PDCCH carrying a first DCI having a full set of scheduling information as described above, and the group-based PDCCH 412A transmitted in the UE-specific search space 404A of the PUE 114A may be a different group-based PDCCH carrying a second DCI having a reduced or minimum set of scheduling information such as TBS, HARQ ID, and/or RV (the remaining DCI field may be filled with padding bits or a shortened version of DCI may be used). For UL transmission between SUE 114A and RAN 102, a time offset 488 may be configured between PDCCH 412 in PUE's UE-specific search space 404A and PDCCH 412 in CUE's UE-specific search space 404B to accommodate latency for transmission via sidelinks 120.

As described above, in some embodiments, data transmission via the sidelink 120 between UEs 114 may be scheduled. In these embodiments, both the Uu link 118 and sidelink 120 may be scheduled and the scheduling of cooperative data transmission may be performed as follows.

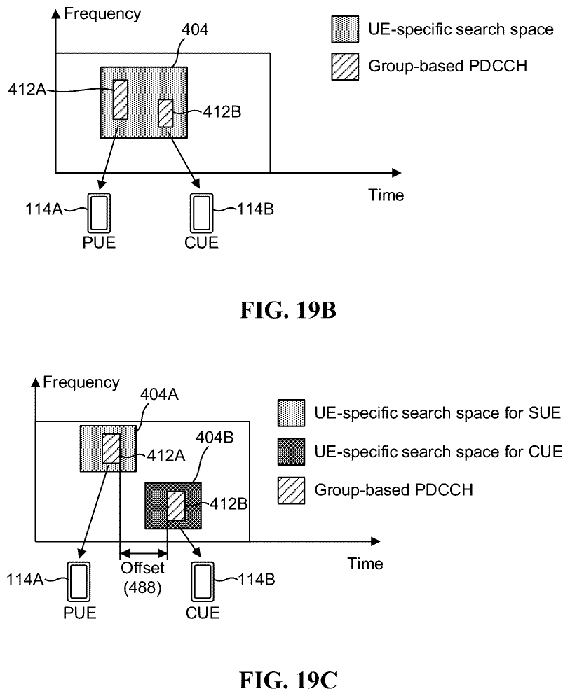

FIGS. 19A to 19C show the scheduling of a cooperative data transmission. To schedule a cooperative UL data transmission (wherein the PUE 144A acts as the SUE), a control signal may be transmitted by the RAN 102 (for example by one or more base stations (for example, gNBs) 112 of the RAN 102) which comprises:
a first group-based PDCCH 412A for SUE 114A wherein the first group-based PDCCH 412A carries scheduling information for a data transmission via the sidelink 120A from the SUE 114A to the CUE 114B; and
a second group-based PDCCH 412B for CUE 114B wherein the second group-based PDCCH 412B carries scheduling information for a data transmission via the Uu link 118B from the CUE 114B to the base station (for example, gNB) 112 (not shown);

The first and second group-based PDCCHs 412A and 412B may be transmitted in the common search space 402 (see FIG. 19A), or in the UE-specific search space 404 of the SUE 114A or the CUE 114B (see FIG. 19B), or in the UE-specific search spaces 404A and 404B of the SUE 114A and the CUE 114B (see FIG. 19C). The first group-based PDCCH 412A may be scrambled and/or CRC-masked by the group RNTI and/or the local UE ID of the SUE 114A. The second group-based PDCCH 412B may be scrambled and/or CRC-masked by the group RNTI and/or the local UE ID of the CUE 114B. Moreover, the first and second group-based PDCCHs 412A and 412B may carry schedule information that contains the same TBS and/or HARQ ID and RV. Similar to that shown in FIG. 18C, for UL transmission between the SUE 114A and the RAN 102, a time offset 488 may be configured between PDCCH 412A for SUE 114A and PDCCH 412B for CUE 114B to accommodate latency on the sidelink 120 between the SUE 114A and the CUE 114B.

Similarly, to schedule a cooperative DL data transmission (wherein the PUE 144A acts as the TUE), a control signal may be transmitted by the RAN 102 (for example by one or more base stations (for example, gNBs) 112 of the RAN 102) which comprises:
a first group-based PDCCH 412A for CUE 114B which carries scheduling information for data transmissions via the Uu link 118B from gNB) 112 to CUE 114B; and
a second group-based PDCCH 412B for CUE 114B which carries scheduling information for a data transmission via the sidelink 120B from CUE 114B to PUE 114A.

The first and second group-based PDCCHs 412A and 412B are transmitted in the group common search space 402 (see FIG. 19A), or in the UE-specific search space 404 of the TUE 114A or the CUE 114B (see FIG. 19B), or in the UE-specific search spaces 404A and 404B of the TUE 114A and the CUE 114B (see FIG. 19C). The first group-based PDCCH 412A may be scrambled and/or CRC-masked by the group RNTI and/or the local UE ID of the TUE 114A. The second group-based PDCCH 412B may be scrambled and/or CRC-masked by the group RNTI and/or the local UE ID of the CUE 114B. Moreover, the first and second group-based PDCCHs 412A and 412B may carry schedule information that contains the same TBS and/or HARQ ID and RV.

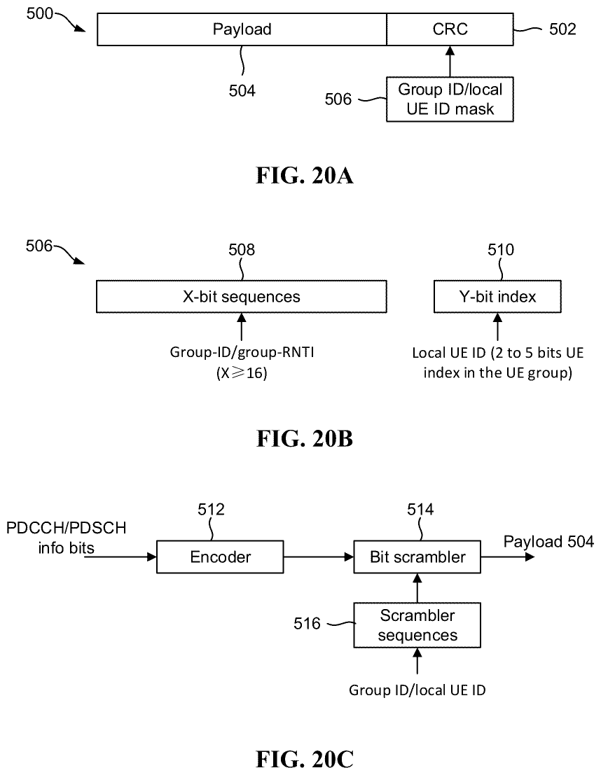

FIGS. 20A to 20C show a CRC-mask and scrambling of a PDCCH signal 500. As shown, the PDCCH signal 500 comprises a payload 504 and a CRC 502. The CRC 502 may be masked with a CRC mask 506 formed by one or more of the group-ID (such as the group-RNTI) and the local UE ID (see FIG. 20A). For example, as shown in FIG. 20B, the X-bit sequence 508 (X≥16) containing group-ID/group-RNTI may be combined with Y-bit sequence 510 containing local UE ID (that is, 2 to 5 bits of the UE identifier of the UE in the UE-cooperation group) to generate the CRC mask 506, which is used to scramble the CRC. As shown in FIG. 20C, the payload 504 of the PDCCH 500 may be obtained by passing the PDCCH information bits through a channel encoder 512 and then through a bit-level scrambler 514. In these embodiments, the bit-level scrambler 514 may be a function of the scrambler sequences 516 of one or more of the group-ID, the local UE ID, and the higher-layer-configured ID. The demodulation reference signal (DMRS) of the PDCCH may be generated by a function of one or more of the group-ID, the local UE ID, and the higher-layer-configured ID. Moreover, the PDCCH candidates for a particular UE in the UE group may be determined by the group-ID and/or the local UE ID.

With above-described details of the group-based control signals, the processes performed by the PUE 114A and CUE 114B in cooperative data transmission (corresponding to step 306 shown in FIGS. 6 and 7) are now described.

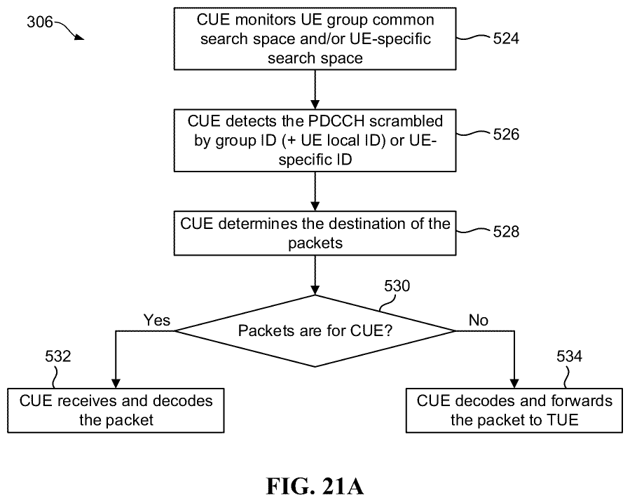

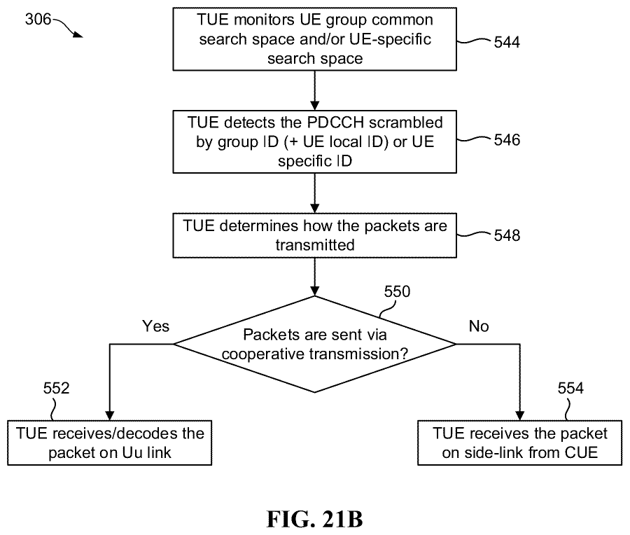

FIG. 21A is flowchart showing a process performed by the CUE 114B in a UE-cooperation group that is performing cooperative DL data transmission, according to one embodiment of this disclosure. As described above, the transmitted data are encoded into one or more packets.

At step 524, after assigned with a group-ID (such as the group-RNTI), the CUE 114B monitors a UE group common search space and/or the UE-specific search space for a PDCCH.

At step 526, the CUE 114B detects the PDCCH, scrambled by the group-ID (such as the group-RNTI) and/or the local UE ID of the CUE 114B, or by the UE-specific ID (such as the UE-specific RNTI) of the CUE 114B, in the UE group common search space and/or the UE-specific search space. When such a PDCCH is detected in the UE group common search space and/or the UE-specific search space, the CUE 114B determines the destination of the packets to be received (step 528).

At step 530, if the PDCCH is scrambled by the UE-specific RNTI of the CUE 114B, the packets to be received are for the CUE 114B itself (that is, a non-cooperative DL data transmission). Then, the CUE 114B receives and decodes the packets transmitted by one or more base stations (for example, gNBs) of the RAN 102 via the Uu link(s) 118 therebetween (step 532).

If, at step 530, the PDCCH is scrambled by the group-ID (such as the group-RNTI) and/or the local UE ID of the CUE 114B, the packets to be received are for the SUE 114A (that is, a cooperative DL data transmission). Then, the CUE 114B receives and decodes the packets sent from the RAN 102 via the Uu link therebetween and forwards the packets to the TUE 114A via the sidelink therebetween (step 534).

FIG. 21B is flowchart showing a process performed by the TUE 114A of a UE-cooperation group that is performing cooperative DL data transmission.

After receiving the group-ID (such as the group-RNTI), the TUE 114A monitors the UE group common search space and/or the UE-specific search space for a PDCCH (step 544).

At step 546, the TUE 114A detects the PDCCH scrambled by the group-ID (such as the group-RNTI) and/or the local UE ID of the TUE 114A, or by the UE-specific ID (such as the UE-specific RNTI) of the TUE 114A in the UE group common search space and/or the UE-specific search space. When such a PDCCH is detected in the UE group common search space and/or the UE-specific search space, the TUE 114A determines how the packets will be transmitted (step 548).

At step 550, if the PDCCH is scrambled by the UE-specific RNTI of the TUE 114A, the packets will be transmitted from the RAN 102 (that is, a non-cooperative DL data transmission). Then, the TUE 114A receives and decodes the packets transmitted by one or more base stations 112 of the RAN 102 via the Uu link(s) 118 therebetween (step 552).

If, at step 550, the PDCCH is scrambled by the group-ID (such as the group-RNTI) and/or the local UE ID of the TUE 114A, the packets will be transmitted from the CUE 114B (that is, a cooperative DL data transmission). Then, the TUE 114A receives and decodes the packets transmitted by the CUE 114B via the sidelink 120 therebetween (step 554).

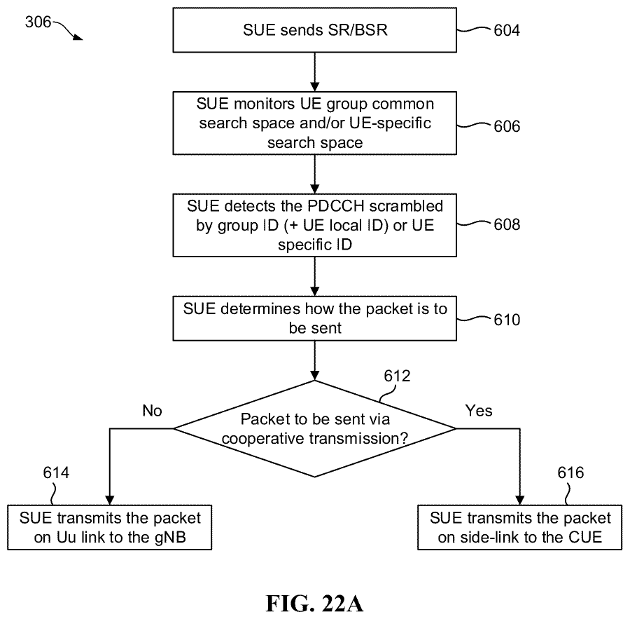

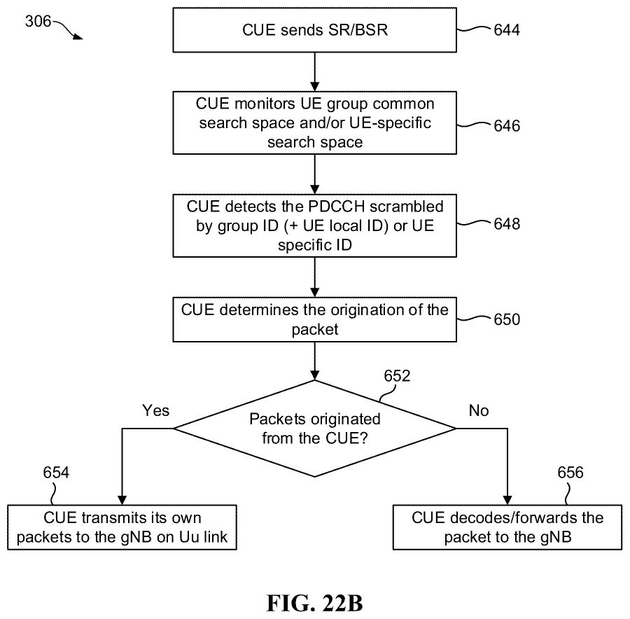

FIG. 22A is flowchart showing a process performed by the SUE 114A in a UE-cooperation group performing cooperative UL data transmission, according to one embodiment of this disclosure.

After receiving the group-ID (such as the group-RNTI), the SUE 114A transmits a SR/BSR to the RAN 102 (step 604), and monitors a UE group common search space and/or a UE-specific search space (step 606) for a PDCCH.

At step 608, the SUE 114A detects the PDCCH scrambled by the group-ID (such as the group-RNTI) and/or the local UE ID of the SUE 114A, or by the UE-specific ID (such as the UE-specific RNTI) of the SUE 114A in the UE group common search space and/or the UE-specific search space. When such a PDCCH is detected in the UE group common search space and/or the UE-specific search space, the SUE 114A determines how it shall transmit the packets (step S610).

At step 612, if the PDCCH is scrambled by the UE-specific RNTI of the SUE 114A, the SUE 114A shall transmit the packets directly to the RAN 102 (that is, in a non-cooperative UL data transmission). Then, the SUE 114A transmits the packets to the RAN 102 (such as the base station (for example, gNB 112) thereof) via the Uu link 118 therebetween (step 614).

If, at step 612, the PDCCH is scrambled by the group-ID (such as the group-RNTI) and/or the local UE ID of the SUE 114A, the SUE 114A shall transmit the packets to the CUE 114B (that is, in a cooperative UL data transmission). Then, the SUE 114A transmits the packets to the CUE 114B via the sidelink 120 therebetween (step 616).

FIG. 22B is flowchart showing a process performed by the CUE 114B in a UE-cooperation group performing cooperative UL data transmission.

After receiving the group-ID (such as the group-RNTI), the CUE 114B sends a SR/BSR to the RAN 102 if the CUE 114B has its own data to transmit to the RAN 102 via non-cooperative data transmission (step 644), and monitors the UE group common search space and/or the UE-specific search space (step 646).

At step 648, the CUE 114B detects the PDCCH scrambled by the group-ID (such as the group-RNTI) and/or the local UE ID of the CUE 114B, or the PDCCH scrambled by the UE-specific ID (such as the UE-specific RNTI) of the CUE 114B. When such a PDCCH is detected, the CUE 114B determines the origination of the packets scheduled for transmission to the RAN 102 (step 650).

At step 652, if the PDCCH is scrambled by the UE-specific RNTI of the CUE 114B, the packets scheduled for transmission shall be the packets originated from the CUE 114B itself (that is, in a non-cooperative UL data transmission comprising its own packets (that is, packets originating at the CUE 114B). Then, the CUE 114B transmits its own packets to the RAN 102 via the Uu link 118 therebetween (step 654).

If, at step 652, the PDCCH is scrambled by the group-ID (such as the group-RNTI) and/or the local UE ID of the CUE 114B, the packets scheduled for transmission shall be the packets originated from the SUE 114A (that is, in a cooperative UL data transmission). Then, the CUE 114B receives and decodes the packets transmitted by the SUE 114 via the sidelink 120 therebetween and forwards the packets to the RAN 102 via the Uu link 118 therebetween (step 656). The packets received via the sidelink 120 in step 656 may be received and decoded before step 648 when CUE 14B detects the PDCCH.

### D. ACRONYM KEY

AP: Access point
ASIC: Application-specific integrated circuit
BSC: Base station controller
BSR: Buffer status request
BTS: Base transceiver station
CDMA: Code division multiple access
CORSET: Control resource set
CPU: Central processing unit
CRC: Cyclic redundancy check
CUE: Cooperative user equipment
D2D: Device-to-Device
DCI: Downlink control information
DL: Downlink
DMRS: Demodulation reference signal
EDGE: Enhanced data rates for GSM evolution
FDMA: Frequency division multiple access
FPGA: Field-programmable gate array
GERAN: GSM EDGE radio access network
GLONASS: Global'naya Navigatsionnaya Sputnikovaya Sistema
gNB: Next generation (or 5G) base station
GNSS: Global navigation satellite system
GPS: Global Positioning System
GPU: Graphic processing unit
GSM: Global system for mobile communications
HARQ: Hybrid automatic repeat request
HARQ-ACK: Hybrid automatic repeat request-acknowledgement
HARQ-NACK: Hybrid automatic repeat request-negative acknowledgement
HSDPA: High speed downlink packet access
HSPA: High speed packet access
HSUPA: High-speed uplink packet access
ID: Identifier
IoT: Internet of things
IP: Internet Protocol
IR: Infrared
LTE: Long Term Evolution
MAC: Medium access control
MIMO: Multiple-input multiple-output
MTC: Machine type communication
NIC: Network interface controller
NR: New Radio
OFDMA: Orthogonal frequency division multiple access
PDA: Personal digital assistant
PDCCH: Physical downlink control channel
PDSCH: Physical downlink shared channel
POTS: Plain old telephone service
PSTN: Public switched telephone network
PUCCH: Physical uplink control channel
PUE: Primary user equipment
PUSCH: Physical uplink shared channel
RAN: Radio access network
RF: Radio frequency
RNC: Radio network controller
RNSS: Regional navigation satellite system
RNTI: Radio network temporary identifier
RRC: Radio resource control
RSS: Received signal strength
RV: Redundancy version
SC-FDMA: Single-carrier frequency-division multiple access
SL: Sidelink
SR: Scheduling request
SUE: Source user equipment
TCP: Transmission control protocol
TDMA: Time division multiple access
TBS: Transport block size
TP: Transmission point
TPU: tensor processing unit
TRP: Transmit/receive point
TTI: Transmission time interval
TUE: Target user equipment
UDP: User datagram protocol
UE: User equipment
UL: Uplink
UMTS: Universal mobile telecommunication system
V2X: Vehicle to anything
WCDMA: Wideband code-division multiple access
WTRU: Wireless transmit/receive unit

Although embodiments have been described above with reference to the accompanying drawings, those of skill in the art will appreciate that variations and modifications may be made without departing from the scope thereof as defined by the appended claims.

1. An apparatus comprising at least one processor coupled with a non-transitory computer readable storage medium storing instructions thereon, where when the instructions executed by the at least one processor, cause the apparatus to perform a method, wherein the method comprising:
scheduling a data transmission between the apparatus and a first user equipment (UE) at least partially via at least one other UE; and
transmitting a control signal for the first UE and the at least one other UE, the control signal carrying scheduling information of the scheduled data transmission between the apparatus and the first UE at least partially via the at least one other UE.

2. The apparatus of claim 1, further comprising:
transmitting at least a first portion of data to the at least one other UE based on the scheduling information for the at least one other UE to forward to the first UE.

3. The apparatus of claim 2, further comprising:
transmitting at least a second portion of the data to the first UE based on the scheduling information.

4. The apparatus of claim 1, further comprising:
receiving at least a first portion of data of the first UE from the at least one other UE based on the scheduling information.

5. The apparatus of claim 4, further comprising:
receiving a second portion of data from the first UE based on the scheduling information; and
combining the at least first portion of data and the second portion of data.

6. The apparatus of claim 1, further comprising:
assigning a group identifier (group-ID) to the first UE and the at least one other UE.

7. The apparatus of claim 6, wherein the control signal comprises at least one physical downlink control channel (PDCCH) signal carrying the scheduling information.

8. An apparatus comprising at least one processor coupled with a non-transitory computer readable storage medium storing instructions thereon, where when the instructions executed by the at least one processor, cause the apparatus to perform a method, wherein the method comprising:
receiving a control signal from one or more RAN nodes of a RAN, the control signal carrying scheduling information for data transmissions between a source node and a destination node;
after decoding the control signal, determining that the source node and the destination node indicated in the scheduling information carried in the control signal are different from the apparatus; and
receiving data based on the scheduling information.

9. The apparatus of claim 8, wherein said receiving the data based on the scheduling information comprises:
receiving the data from a second UE based on the scheduling information; and
wherein the method further comprises:
transmitting the received data to the one or more RAN nodes of the RAN based on the scheduling information.

10. The apparatus of claim 8 wherein said receiving the data based on the scheduling information comprises:
receiving the data from the one or more RAN nodes of the RAN based on the scheduling information; and
wherein the method further comprises:
transmitting the received data to a second UE.

11. The apparatus of claim 8, wherein the control signal comprises a PDCCH signal carrying the scheduling information.

12. The apparatus of claim 11, wherein the PDCCH signal is scrambled by at least a group-ID.

13. The apparatus of claim 11, wherein said receiving the control signal from the one or more RAN nodes of the RAN comprises:
searching for the PDCCH signal in a group common search space; and
retrieving the scheduling information carried in the PDCCH signal received in the group common search space.

14. The apparatus of claim 13, wherein the group common search space is in a control resource region associated with a common search space.

15. An apparatus comprising at least one processor coupled with a non-transitory computer readable storage medium storing instructions thereon, where when the instructions executed by the at least one processor, cause the apparatus to perform a method, wherein the method comprising:
receiving a control signal from one or more RAN nodes of a RAN, the control signal carrying scheduling information for data transmission between the apparatus and the one or more RAN nodes of the RAN at least partially via at least one other UE; and
transmitting or receiving at least a first portion of data to or from the at least one other UE.

16. The apparatus of claim 15, wherein said transmitting or receiving the at least first portion of data from the at least one other UE comprises:
receiving the at least first portion of data from the at least one other UE based on the scheduling information.

17. The apparatus of claim 16, further comprising:
receiving a second portion of data from the one or more RAN nodes of the RAN based on the scheduling information; and
combining the at least first portion of data and the second portions of data.

18. The apparatus of claim 15, wherein said transmitting or receiving the at least first portion of data to or from the at least one other UE comprises:
transmitting the at least first portion of data to the at least one other UE for the at least one other UE to transmit to the one or more RAN nodes of the RAN.

19. The apparatus of claim 18, wherein said transmitting the at least first portion of data to the at least one other UE comprises:
transmitting the at least first portion of data to the at least one other UE based on the scheduling information for the at least one other UE to transmit to the one or more RAN nodes of the RAN.

20. The apparatus of claim 18, further comprising:
transmitting a second portion of data to the one or more RAN nodes of the RAN based on the scheduling information.
